(19) United States
(12) Patent Application Publication
(10) Pub. No.: US 2026/0073752 A1
(43) Pub. Date: Mar. 12, 2026

(54) ADAPTIVE INPUT OPTIONS FOR PRODUCT SELECTION

(71) Applicant: PepsiCo, Inc., Purchase, NY (US)

(72) Inventors: Eleonor Dorin STOENESCU, Stamford, CT (US); Robert BALSTAD, New Milford, CT (US); Terry Tae-il CHUNG, New Fairfield, CT (US)

(21) Appl. No.: 18/828,587

(22) Filed: Sep. 9, 2024

(51) Int. Cl. G07F 9/02; G06F 3/0482; G06F 3/04842

(52) U.S. Cl. CPC G07F 9/023; G06F 3/0482; G06F 3/04842

(57) ABSTRACT

A product dispensing machine includes a user interface configured to receive user selections and to present user selectable options. The product dispensing machine also includes a controller configured to control the user interface to present user selectable options in order of priority. The controller is configured to aggregate the user selections and to dynamically adjust the priority of the user selectable options based on the aggregated user selections.

### BACKGROUND

Existing product dispensing machines, such as vending machines and soda fountains, can be a convenient way for customers to purchase goods. Product dispensing machines have user interfaces that present options enabling customers to select products for purchase. Existing user interfaces display options unequally, such that some options are easier to notice and access than other. Existing interfaces tend to be static after initial setup, and may therefore make popular options relatively difficult to notice and access, making the interface inefficient potentially turning away customers that are not interested in the more easily noticed options.

### BRIEF SUMMARY

A need exists for a product dispensing machine with an adaptive user interface. In some aspects of the present disclosure, the product dispensing machine may include a controller that controls the user interface and aggregates usage data in the form of interactions with the user interface. The controller may learn from user interactions to find more popular options and cause the user interface to present more popular options more prominently, thereby making the product dispensing machine more efficient to interact with. The controller may also particularize its learning to different situations, thereby causing the user interface to present the most relevant options prominently in various situations.

Some aspects of the present disclosure relate to a product dispensing machine. The product dispensing machine may comprise a user interface configured to receive user selections and to present user selectable options. The product dispensing machine may comprise a controller configured to control the user interface to present user selectable options in order of priority. The controller may be configured to aggregate the user selections, to change relative priorities of the user selectable options based on the aggregated user selections, and to control the user interface to change a presentation of the user selectable options to reflect the changing of the priorities.

In some embodiments according to the foregoing, the controller may be configured to control the user interface to present the user selectable options in a list. The list may be ordered by priority. The controller may be configured to control the user interface to change an order in which the user selectable options are presented in the list to reflect the changing of priorities.

In some embodiments according to any of the foregoing, the controller may be configured to change the relative priorities of the user selectable options by changing priority of individual user selectable options in proportion to the individual user selectable options' relative frequency within the aggregated user selections.

In some embodiments according to any of the foregoing, the controller may be configured to follow a schedule comprising a first block and a second block. The controller may be configured to control the user interface to present fewer user selectable options during the first block than during the second block.

In some embodiments according to any of the foregoing, the controller may be configured to create the schedule based on the aggregated user selections by analyzing the aggregated user selections for patterns in frequency of interactions with the user interface. The controller may be configured to predict future frequencies of interactions with the user interface based on the patterns. The first block may be a time within the schedule for which the controller predicts greater frequency of interactions with the user interface than during the second block based on the patterns.

In some embodiments according to any of the foregoing, the controller may be configured to further change the relative priorities of the user selectable options by increasing priority of user selectable options that require usage of any ingredient stocked for the product dispensing machine and having an expiration date less than a predetermined amount of time in the future.

In some embodiments according to any of the foregoing, the controller may be configured to further change the relative priorities of the user selectable options by increasing priority of individual user selectable options in inverse proportion to time remaining before expiration of ingredients stocked for the vending machine and respective to those individual user selectable options.

In some embodiments according to any of the foregoing, the controller may be configured to further change the relative priorities of the user selectable options based on user selections aggregated by a cohort of related dispensing machines.

In some embodiments according to any of the foregoing, the cohort may be limited to a predefined geographic region within which the product dispensing machine is installed.

In some embodiments according to any of the foregoing, the controller may be configured to identify a characteristic of a user presently interacting with the product dispensing machine and to further change relative priorities of the user selectable options based on the characteristic.

Some aspects of the present disclosure relate to a product dispensing machine. The product dispensing machine may comprise a user interface configured to present an options spectrum comprising user selectable options and to receive user selections of the user selectable options. Each of the user selectable options may correspond to a different value of a product dispensation parameter. An individual user selectable option among the user selectable options may correspond to a variable value. The product dispensing machine may comprise a dispenser configured to dispense a product in a manner that varies depending on the product dispensation parameter. The product dispensing machine may comprise a controller. The controller may be configured to aggregate the user selections and to change the variable value based on the aggregated user selections. The controller may be configured to, following selection of the individual user selectable option, set the product dispensation parameter to the variable value and control the dispenser to dispense the product according to the product dispensation parameter.

In some embodiments according to the foregoing, the options spectrum may comprise a first user selectable option, a second user selectable option, and the individual user selectable option. The first user selectable option may correspond to a first value of the product dispensation parameter. The second user selectable option may correspond to a second value of the product dispensation parameter. The variable value may be between the first value of the product dispensation parameter and the second value of the product dispensation parameter. The controller may be configured to change the variable value based on relative quantities of the first user selectable option and the second user selectable option within the aggregated user selections.

In some embodiments according to any of the foregoing, the controller may be configured to change the variable value based on the relative frequencies of the first user selectable option and the second user selectable option by changing the variable value if at least a threshold proportion of the aggregated user selections comprise the first user selectable option.

In some embodiments according to any of the foregoing, the threshold proportion may be a predetermined proportion.

In some embodiments according to any of the foregoing, the threshold proportion may be a function of a proportion of the aggregated user selections that comprise the second user selectable option.

In some embodiments according to any of the foregoing, the controller may be configured to change the variable value to be nearer to the first value if at least the threshold proportion of the aggregated user selections comprise the first user selectable option.

In some embodiments according to any of the foregoing, the product dispensation parameter may be an amount of a product ingredient to be dispensed.

In some embodiments according to any of the foregoing, the product dispensation parameter may be an intensive property of a product ingredient to be dispensed.

Some aspects of the present disclosure relate to a product dispensing machine. The product dispensing machine may comprise a user interface configured to receive user selections and to present user selectable options. The product dispensing machine may comprise a scanner configured to identify a characteristic of a person. The product dispensing machine may comprise a controller configured to control the user interface to present user selectable options in order of priority. The controller may be configured to use the scanner to identify the characteristic of a user presently interacting with the product dispensing machine. The controller may be configured to change relative priorities of the user selectable options based on the characteristic. The controller may be configured to control the user interface to change the presentation of the user selectable options to reflect the changing of the priorities.

In some embodiments according to the foregoing, the characteristic may be a demographic category. The controller may be configured to increase relative priorities of individual user selectable options in proportion to a measure of the individual user selectable options' popularity with users in the demographic category.

Additional embodiments and advantages of the disclosure will be set forth, in part, in the description that follows, and will flow from the description, or can be learned by practice of the disclosure.

It is to be understood that both the foregoing summary and the following detailed description are exemplary and explanatory only, and do not restrict the scope of the claims.

### BRIEF DESCRIPTION OF THE DRAWINGS

FIG. 1A is a diagram of a system according to an aspect of the present disclosure.

FIG. 1B schematically illustrates an intelligent distribution system according to an aspect of the present disclosure.

FIG. 2 is an illustration of a product dispensing machine according to some aspects of the present disclosure.

FIG. 3 illustrates a process applicable to the product dispensing machine according to some aspects of the present disclosure.

FIG. 4 illustrates an example of a change to a user interface according to some aspects of the process of FIG. 3.

FIG. 5 illustrates an example of a change to a user interface according to some aspects of the process of FIG. 3.

FIG. 6 illustrates an example of a change to a user interface according to some aspects of the process of FIG. 3.

FIG. 7 illustrates an example of a learning operation according to some aspects of the process of FIG. 3.

FIG. 8 illustrates an example of a learning operation according to some aspects of the process of FIG. 3.

FIG. 9A illustrates an example of a user interface of a product dispensing system 2.

FIG. 9B illustrates multiple stages of a user interface of a product dispensing system.

FIG. 10 illustrates an example of a learning operation according to some aspects of the process of FIG. 3.

FIG. 11 illustrates an example of a change to a user interface according to some aspects of the process of FIG. 3.

FIG. 12 illustrates an example of a change to a user interface according to some aspects of the process of FIG. 3.

FIG. 13 illustrates an example of a learning operation according to some aspects of the process of FIG. 3.

### DETAILED DESCRIPTION

The present invention will now be described in detail with reference to embodiments thereof as illustrated in the accompanying drawings. References to “one embodiment,” “an embodiment,” “an example embodiment,” “some embodiments,” etc., indicate that the embodiment described may include a particular feature, structure, or characteristic, but every embodiment described may not necessarily include that particular feature, structure, or characteristic. Similarly, other embodiments may include additional features, structures, or characteristics. Moreover, such phrases are not necessarily referring to the same embodiment. When a particular feature, structure, or characteristic is described in connection with the embodiment, it is submitted that it is within the knowledge of one skilled in the art to effect such feature, structure, or characteristic in connection with other embodiments whether or not explicitly described.

The terms “invention,” “present invention,” “disclosure,” or “present disclosure” as used herein are non-limiting terms and are not intended to refer to any single embodiment of the particular invention but encompasses all possible embodiments as described in the application.

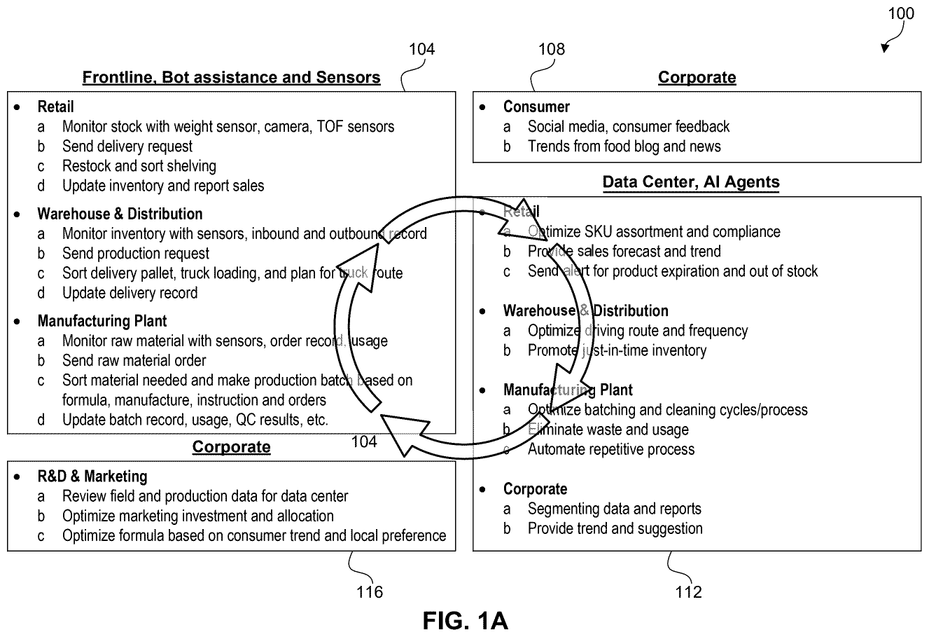

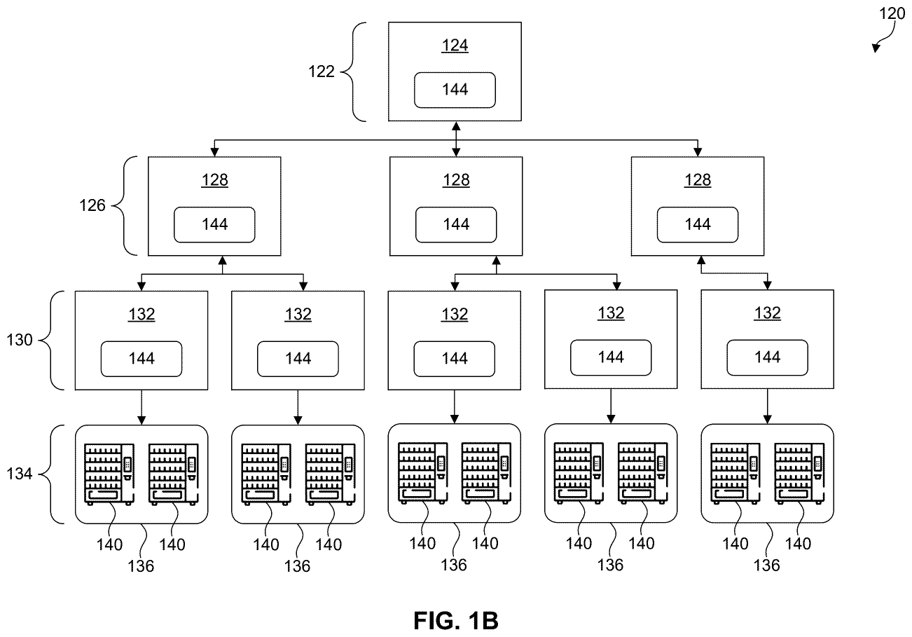

FIG. 1A illustrates a system 100 for applying machine learning to product manufacture and development. Any machine learning models or processes mentioned herein can, in some examples, be deep learning models or processes. System 100 comprises a distribution block 104 and a reception block 108. Distribution block 104 and reception block 108 each represent multiple possible factors that can be quantified and provided as inputs to Artificial Intelligence (“AI”) Agents block 112. AI Agents block 112 represents one or more machine learning models used to identify associations between any inputs, considered individually or in any combination, and any outputs. System 100 further comprises decision block 116, which represents decisions regarding product manufacture and distribution that can be made in view of outputs from AI Agents block 112. The “blocks” of system 100 refer to groups of processes, subsystems, and devices, and do not necessarily require any particular structure.

Distribution block 104 comprises sensor data and records relating to sales, logistics, and manufacturing. Distribution block 104 can comprise, for example, retail data. Retail data can comprise sales volume. For example, retail data can comprise volume of sales to consumers, volume of sales to retailers, or both. In some examples, retail data can be derived from sales records. Retail data can also include consumer data associated with a purchase. An example of said consumer data can be anonymized demographic data, location data, purchase volume data, and the amount spent for a particular product. Such data would only be collected where legal or where a consumer has willingly and knowingly consented to the collection of said data. In further examples, retail data can be derived from sensors within an automated stock monitoring system at a retail location. Retail locations can be, in various examples, a retail store, an automated merchantry system, a controlled access product container, a vending machine, or any other location from which consumers may purchase product. Sensors within the automated stock monitoring system can be, for example, be sensors configured to measure a quantity of product on a shelf or in another storage area. For example, sensors for monitoring a quantity of stock can comprise weight sensors applied to a shelf or other surface upon which stock can be stored. In further examples, sensors for monitoring a quantity of stock can comprise cameras directed at a space within which stock can be stored. In further examples, the cameras can be time of flight (“TOF”) cameras. TOF cameras can be configured to measure a quantity of stock by, for example, measuring a space occupied by the stock. When stock falls below a predetermined threshold quantity, an order can be placed automatically or by a human operator for more product to be delivered to the retail location. Upon arrival of the ordered product, the storage space of the retail location can be restocked and inventory and sales records can be updated. In examples wherein the order is placed automatically, the automatic order can also be automatically entered into the sales data. In further examples, the sales data can be updated automatically to reflect changes in stock at the retail location based on the measurements of the quantity of stock by the automated stock monitoring system.

Distribution block 104 can further comprise warehouse data. Warehouse data can comprise volume of product movement into and out of a warehouse. A warehouse can be, for example, a location where product is stored before distribution to a retail location. In some examples, warehouse data can be derived from shipment and order records. In further examples, warehouse data can be derived from sensors within an automated inventory monitoring system at the warehouse. Similar to the above described automated stock monitoring systems, an automated inventory monitoring system can comprise sensors configured to measure a quantity of inventory of product at the warehouse. Such sensors can comprise, in various examples, weight sensors configured to measure a weight of product stored on a surface or cameras, such as TOF cameras, configured to measure a space occupied by product. Automated inventory monitoring system can further be configured to request production and delivery of product based on inventory data. For example, automated inventory monitoring system can be configured to request production of a product when inventory of the product falls below a predetermined threshold. In further examples, automated inventory monitoring system can be configured to request production of a product at a rate equal to actual or forecasted rates of inventory leaving the warehouse. The rate of inventory leaving the warehouse can be derived from measurements of inventory quantity acquired with the above mentioned sensors of the automated inventory monitoring system. Warehouse data of distribution block 104 can comprise production requests placed by human operators, production requests placed by automated inventory monitoring systems, or both.

Distribution block 104 can further comprise manufacturing data. Manufacturing data can comprise raw material quantities, raw material usage rates, and production volume. Manufacturing data can further comprise order volume of raw material. Orders for raw material can be placed, in various examples, by human operators, by automated systems for monitoring raw material quantity or raw material usage, or both. In further examples, manufacturing data can comprise quality control data, such as, for example, a proportion of product found to have defects. Manufacturing data can further comprise data such as level of energy consumption associated with a manufacturing location or level of energy consumption associated with the manufacturing of a product. As will be discussed later, such data can be analyzed to predict and recommend the most environmentally friendly logistics, manufacturing, distribution, and sales solutions.

Operations at any of the foregoing sources of information within distribution block 104, including retail locations, warehouses, and factories or other manufacturing facilities, can be conducted with the assistance of machinery, such as robots or other devices. Such machinery can be automated or human operated. In each location, the machinery can be used to move product, materials, or both. For example, at retail locations, machinery can be used to restock shelves. In further examples, at relocations, machinery can be used to sort products within a storage space. In some examples wherein the machinery comprises an automated robot, the robot can cooperate with the automated stock monitoring system to restock product as orders of new stock arrive at the retail location. Similarly, product handling machinery can be used at a warehouse to sort inventory and otherwise move product about the warehouse. The product handling machinery can be used, for example, to unload newly arrived product from a delivery vehicle, load product onto a delivery vehicle to fulfill orders, or both. Such warehouse product handling machinery can be automated product handling machinery. Automated product handling machinery in some embodiments can comprise one or more automated robots. Automated systems can also be used to develop routes for delivery vehicles conveying product to or from the warehouse. Similarly, product handling machinery can be used at a manufacturing facility to transport raw material and product within the facility, unload raw material from a delivery vehicle, load product onto a delivery vehicle, manufacture the product, or any combination of the foregoing.

Any of the above described machinery for use at retail locations, warehouses, or manufacturing facilities can be provided with sensors or any type for monitoring operation of the machinery. For example, the sensors can be configured to take measurements from which product sales, material usage, or both can be derived. The measurements can be comprised by data of distribution block 104 corresponding to the location of the machinery. Thus, retail data can comprise measurements from sensors of product transportation machinery at retail locations. Warehouse data can similarly comprise measurements from product transportation machinery at warehouses. Manufacturing data can comprise measurements from product or material transportation machinery, measurements from product manufacturing machinery, or both. Additionally or alternatively, the data comprised by distribution block 104 can comprise logs of operations performed by the machinery, instructions given to the machinery, or both.

Reception block 108 comprises information gathered related to public opinion regarding the product or products to which distribution block relates or other products in a related category. Reception block 108 can comprise information acquired by web analytics techniques, such as aggregating discussion of relevant products and concepts from social media, consumer reviews and feedback, blogs, and news. Such aggregated information can be processed to create one or more market insights. The market insights can comprise, for example, whether prevailing attitudes toward a product or product feature are positive or negative, to what degree prevailing attitudes toward a product or product feature are positive or negative, how much certain product types or product features are discussed, what product types or product features are discussed most frequently, or trends concerning any of the foregoing over time.

AI Agents block 112 comprises use of one or more machine learning models to analyze inputs from distribution block 104 and reception block 108 and output operational recommendations. All inputs to AI Agents block 112 can be aggregated into a dataset used to train the one or more machine learning models. AI Agents block can, in some examples, generate operational recommendations concerning order volume and timing from retail locations to warehouses, from warehouses to manufacturing facilities, and from manufacturing facilities to suppliers of raw materials. In further examples, a machine learning model or models of AI Agents block 112 can be configured to generate operational recommendations concerning what thresholds of stock or inventory at retail locations or warehouses should prompt placement of an order for more product and what the volume of the order should be. Such operational recommendations can be optimized to avoid running out of stock at retail locations or inventory at warehouses. In further examples, such recommendations can be optimized to avoid running out of raw material at a manufacturing plant. Recommendations concerning order placement for product at warehouses and order placement for raw materials and rate of manufacture at manufacturing facilities can be coordinated to minimize a chance of order volume from warehouses exceeding the production capacity of manufacturing facilities. Any such operational recommendations can include prospective changes in order volume according to periodic changes in demand discovered from analysis of information provided to the machine learning model(s) of AI Agents block 112. For example, the machine learning model(s) of AI Agents block 112 may recommend greater order volume, higher stock or inventory thresholds below which orders should be placed, or both, in advance of expected weekly or seasonal increases in demand. In further examples, such operational recommendations can be optimized to reduce a likelihood of product remaining unsold until expiring of raw material remaining unused until expiring by reducing order placement volume or frequency in advance of expected weekly or seasonal decreases in demand. In further examples, relative positivity or negativity of any of a variety of factors, such as, for example, total revenue, total sales, total expenses, wasted product, wasted raw materials, demand exceeding production capacity, defective product occurrence frequency, and running out of stock, inventory, and raw materials, can be weighted and provided to the machine learning model(s) of AI Agents block 112, and the machine learning model(s) can be configured to provide operational recommendations expected to result in maximally positive outcomes. Operational recommendations according to any of the foregoing examples can be provided to human operators or pushed to any automated order placement systems associated with retail locations, warehouses, or manufacturing facilities.

The machine learning model(s) of AI Agents block 112 can also be configured to generate operational recommendations meant to provide the most environmentally friendly approach. For example, recycling can be promoted by taking GPS sensor data to determine the location a consumer good will be shipped to. This can be cross-referenced with local regulations identifying which type of packaging can be recycled in that area so that the machine learning models optimize recycling by recommending the use of packaging materials that can recycled in the location it is being shipped to. Similarly, the machine learning model(s) can be used to determine the most fuel-efficient supply chain and logistical solutions by, e.g., recommending: (1) routes that take up the least amount of fuel or recommending supply carriers that utilize hybrid or electric vehicle fleets; and/or (2) delivery schedules that take up the least amount of energy or fuel. Similarly, the machine learning model(s) can recommend manufacturing locations and/or delivery hubs that use the least energy or consume the least water, thereby further reducing the environmental impact associated with delivering products to consumers. Similarly, the machine learning model(s) can create commercial incentives to promote the most environmentally friendly approaches from manufacturing sites, shipping sites, retail sites, warehouses, retailers and consumers. For example, retailers that reach certain recycling goals can be rewarded with discounts, free products, cheaper delivery, earlier access to new products, or being prioritized for popular products or new releases. The machine learning model(s) can also be used to develop or incentivize efficient energy management protocols, such as adjusting a thermostat to a higher setting during closing hours or adjusting the thermostat to a lower setting before regular business hours, such as when sales or production occur. Systems may also be automated to adhere to such energy management protocols. Thus, in some embodiments, facilities can be equipped with controllers governing thermostats to automatically adjust to lower temperatures at closing time and higher temperatures at or before opening time.

The machine learning model(s) of AI Agents block 112 can also be configured to generate operational recommendations for consideration by business professionals, such as individuals involved in corporate governance. Such operational recommendations can concern, for example, long term forecasts for demand for certain product types, trends in consumer sentiment regarding product types or product features, and recommendations for product development. For example, if the machine learning model(s) of AI Agents block 112 determine, from inputs received from reception block 108, that consumer demand for a product type or product feature not offered by the organization operating the machine learning model(s), the machine learning model(s) can recommend developing a product of that type and/or having that feature. Additionally or alternatively, the operational recommendations for consideration by business professionals can comprise recommendations relating to messages to emphasize or avoid in product marketing.

Decision block 116 comprises consideration of the operational recommendations output by the machine learning model(s) of AI Agents block 112 by any human recipients of the operational recommendations. The human recipients comprise, in various examples, engineers, research and development teams, marketing professionals, business professionals, factory operators, vehicle operators, or any other recipients appropriate for the subject matter of the recommendations given. At decision block 116, the human recipients determine which operational recommendations from the machine learning model(s) of AI Agents block 112 to implement and to what extent those recommendations will be implemented. For example, certain product development recommendations may be implemented, whereby new products may be developed and then produced at manufacturing facilities, while other product development recommendations may be ignored or deferred. As another example, steps to reduce power/water consumption and optimize resources in manufacturing, warehousing, retail, and other facilities can be prioritized and implemented based on operational recommendations output by the machine learning model(s). Similarly, logistics related operational recommendations may be implemented throughout the various elements of decision block 104, such as by altering order volumes, order frequencies, delivery routes, workflows in manufacturing facilities, and traffic patterns within storage areas of retail locations, warehouses, and manufacturing facilities. In further examples, certain marketing recommendations may be implemented, such as by adjusting marketing investment across various media, various locations, or both. In still further examples, marketing recommendations can be implemented by developing new marketing campaigns, retiring certain existing marketing campaigns, or both. In some embodiments, a machine learning model or models may be trained to determine which operational recommendations to implement, as discussed above.

Aspects of the above described system 100 can be implemented in an intelligent distribution system 120 as shown in FIG. 1B. Intelligent distribution system 120 can comprise one or more device layers such as a central layer 122, a regional distribution layer 126, an end distribution layer 130, and a retail layer 134. Retail layer 134 can comprise individual retail devices 136. In some embodiments, individual retail devices 136 can be systems or facilities operating a plurality of retail machines 140, such as for example, vending machines, automated merchants, and sales registers. It is understood that intelligent distribution system 120 may be implemented with any number of layers and is not limited to the layers depicted in FIG. 1B.

End distribution layer 130 can comprise end distributor devices 132, such as warehouses as described above. End distribution layer 130 includes components and, in some embodiments, facilities, which are configured to distribute product to one or more retailers, which may be represented by retail devices 136. Thus, in some embodiments, each end distributor device 132 can include components, facilities, or both, configured for use in the distribution of product to one or more retailers or retail devices 136. Regional distribution layer 126 can comprise multiple regional distributor devices 128. Regional distribution layer 126 includes components and, in some embodiments, facilities, which are configured to distribute product to one or more end distributor devices 132 within a respective geographic region. Thus, in some embodiments, each regional distributor device 128 can include components, facilities, or both, configured for use in the distribution of product to one or more end distributors or end distributor devices 132. Central layer 122 can comprise a central decision maker device 124, such as a central computer or a cloud computer, configured to aggregate sales and distribution data from regional distributor devices 128.

Intelligent distribution system 120 can comprise a machine learning network distributed across multiple layers of intelligent distribution system 120. For example, the machine learning network can comprise components 144. In some embodiments, each component 144 of the machine learning network can comprise a separate, independently operating machine learning model. In further embodiments, components 144 within regional distribution layer 126 can each be a portion of a collective machine learning machine operating across regional distribution layer 126. In further embodiments, components 144 within end distribution layer 130 can each be or comprise a portion of a collective machine learning model operating across end distribution layer 130. In further embodiments, all components 144 of machine learning model can be or comprise portions of a single machine learning model operating across central layer 122, regional distribution layer 126, and end distribution layer 130 of intelligent distribution system 120. The machine learning model or models according to any of these embodiments can be any type of machine learning model. In some embodiments, each machine learning model can be a neural network.

With respect to the system 100 described above, distribution block 104 can comprise components 144 of the machine learning network within regional distribution layer 126, end distribution layer 130, and retail layer 134. Either or both of AI Agents block 112 and decision block 116 can comprise part or all of the component 144 within central layer 122.

In some embodiments, each regional distributor device 128 can host one or more components 144 of the machine learning network. In some embodiments, each end distributor device 132 can host one or more components 144 of the machine learning network. In some embodiments, the machine learning network can comprise further components 144 within retail layer 134. For example, components 144 within retail layer 134 can be hosted by computer hardware installed within individual retail devices 136. In some embodiments, components 144 can be hosted by computer hardware within individual retail machines 140. Thus, in some embodiments, each retail device 136 can host one or more components 144 of the machine learning network.

Components 144 of the distributed machine learning network can be configured to make predictions based on data received from across various portions of the intelligent distribution system 120. Components 144 within different layers 122, 126, 130, 134 can have different roles in the distributed machine learning network. Thus, in some embodiments, each component 144 within end distribution layer 130 can be configured to predict, based on end distributor data comprising distribution records from a respective end distributor device 132 to one or more retail devices 136, future distribution patterns from the end distributor device 132 to the retail devices 136. In some embodiments, each component 144 within end distribution layer 130 can also be configured to optimize distribution practices from the end distributor data for environmental friendliness. The distribution practices can include, for example, distribution routes, distribution schedules, thermostat temperature settings, thermostat schedules, or any combination of the foregoing, and components 144 can be configured to optimize the practices for environmental friendliness by finding solutions that satisfy all necessary criteria (such as timely delivery and avoidance of spoilage) while minimizing energy expenditure or material usage. In some embodiments, the end distributor data can include distribution records from a respective end distribution device 132 to retail devices 136, such as retail facilities. In some embodiments, the end distributor data can include retail data received from the retail devices 136. In some embodiments, the retail data can include records generated by an automated stock monitoring system installed in at least one of the retail devices 136. In some embodiments, retail data can include any one or any combination of sales performance, power usage, machine health, consumer analytic data such as consumer demographics, foot traffic within a retail location or within a predetermined proximity of a retail machine 140, conversion rate of new customers, time of sale, location of sale, volume of sale, sale price, and vendor identity or retailer identity. In some embodiments, any or all of the retail data can be acquired through retail machines 140. In some embodiments, the end distributor data can further comprise retail data received from the retail devices 136, such as product sales volumes from the retail devices 136. In some embodiments, the retail data can comprise records of product inventory generated by automated inventory monitoring systems installed at one or more of the retail devices 136. In some embodiments, the retail data can include maintenance data from retail devices 136. In some embodiments, the maintenance data from retail devices 136 can include maintenance data from retail machines 140. Maintenance data can include records of when retail machines 140 fail, what aspects of retail machines 140 fail, when repairs are made to retail machines 140, and what repairs are made to retail machines 140.

In some embodiments, each component 144 within regional distribution layer 126 can be configured to predict, based on regional distributor data comprising the distribution records from a respective plurality of the end distributor devices 132, future regional sales volume within a geographic region within which the plurality of end distributor devices 132 is located. The regional sales volume can be a volume of sales of products distributed by end distributor devices 132 to retail devices 136. In some embodiments, the distribution records can comprise operation logs from product handling machinery installed in at least one of the end distributor devices 132. In some embodiments, the regional distributor data upon which the component or components 144 of the regional distribution layer 126 can comprise any one or any combination of records of distribution within the geographic region, records of manufacture of products to be distributed within the geographic region, usage rate of materials for manufacture of products to be distributed within the geographic region, inventory of materials to be used in manufacture of products to be distributed within the geographic region, stock of products available to be distributed within the geographic region, records of service calls, records of restock orders, and records of orders to move products. In some embodiments, each component 144 within regional distribution layer 126 can also be configured to optimize distribution practices from the regional distributor data for environmental friendliness. The distribution practices can include, for example, distribution routes, distribution schedules, thermostat temperature settings, thermostat schedules, manufacturing processes, or any combination of the foregoing, and components 144 can be configured to optimize the practices for environmental friendliness by finding solutions that satisfy all necessary criteria (such as fuel efficiency, timely delivery, and avoidance of spoilage) while minimizing energy expenditure or material usage.

In some embodiments, decision maker device 124 can host one or more components 144 of the machine learning network. In some embodiments, the component 144 within central layer 122 can be a central component configured to predict, based on central data comprising the future regional sales volumes predicted by the components 144 within regional distribution layer 126, future global sales volumes of the products distributed by end distributor devices 132 to retail devices 136. In some embodiments, the component 144 within central layer 122 can be a central component further configured to predict, based on the central data, future manufacturing loads necessary to meet the predicted further global sales volumes. This prediction can also be used to optimize an approach to minimize environmental impact while keeping costs down. Thus, in some embodiments, each component 144 within central layer 122 can also be configured to optimize distribution practices from the central data for environmental friendliness. The distribution practices can include, for example, distribution routes, distribution schedules, thermostat temperature settings, thermostat schedules, manufacturing processes, or any combination of the foregoing, and components 144 can be configured to optimize the practices for environmental friendliness by finding solutions that satisfy all necessary criteria (such as fuel efficiency, timely delivery, and avoidance of spoilage) while minimizing energy expenditure or material usage. The component 144 within central layer 122 can also, in some embodiments, create a holistic and traceable record to keep track of green house gas emission to make sure emissions are on track with sustainability goals. In some embodiments, the central component can be partly or entirely comprised by AI Agents block 112 as described above, decision block 116 as described above, or both AI Agents block 112 and decision block 116. Thus, the central data can include any of the information described above as being available to or used by the AI Agents block 112, the decision block 116, or both.

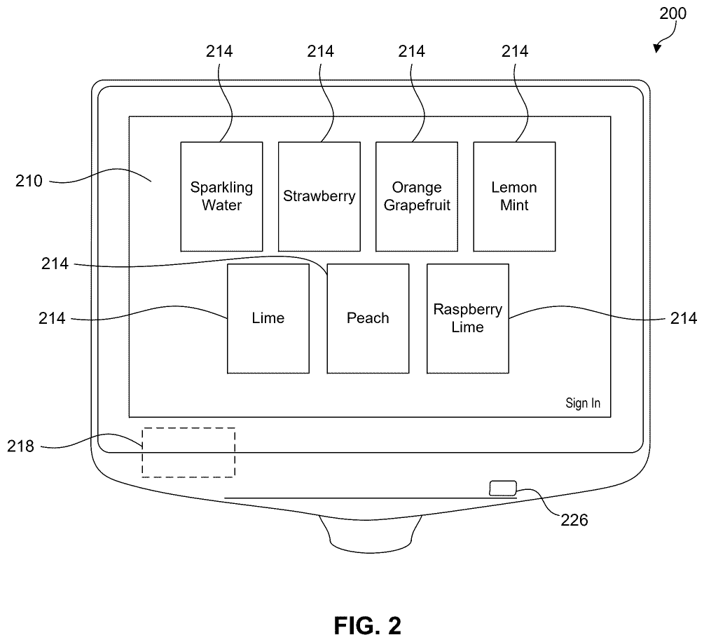

FIG. 2 illustrates a product dispensing machine 200. Product dispensing machine 200 comprises a user interface 210. User interface 210 is configured to display user selectable options 214. Product dispensing machine 200 comprises a controller 218 configured to control user interface 210. User interface 210 of the illustrated embodiment comprises a touch screen. However, user interface 210 can be any type of interface capable of displaying a dynamically changeable group of user selectable options 214 and to receive inputs corresponding to the displayed options. Accordingly, user interface 210 according to further embodiments can comprise, for example, a screen paired with a mouse or an arrangement of buttons for allowing a user to select the options 214 presented on the screen.

Product dispensing machine 200 can further comprise a dispenser 222 for dispensing products based on inputs of user selectable options 214 made through user interface 210. In embodiments wherein product dispensing machine 200 is a beverage dispensing machine, as in the illustrated embodiment, dispenser 222 can comprise a nozzle for dispensing liquids. In further embodiments, dispenser 222 can comprise any other features in addition to or in the alternative to a nozzle as appropriate for dispensing the range of products beverage dispensing machine 200 is configured to offer.

Beverage dispensing machine 200 can optionally comprise a scanner 226. Scanner 226 can comprise, for example, any one or any combination of a camera, a barcode reader, a QR code reader, a card reader, a near field communication (“NFC”) device, or any other type of scanner. In various embodiments, scanner 226 can be used, for example, to receive payment, to read identification tokens, to optically identify users of product dispensing machine 200, to optically discover demographic information about users of product dispensing machine 200, or any combination of the foregoing.

User interface 210 can be a dynamic user interface configured to display user selectable options 214 differently in response to changing instructions from controller 218. Controller 218 can be configured to learn from selections of user selectable options 214 over time and to change controllers' 218 instructions to user interface 210 based on the learning.

User selectable options 214 can be grouped into different categories. Categories of user selectable options 214 can comprise, for example, a flavor category, wherein each user selectable option 214 within the flavor category corresponds to a flavor of a beverage to be dispensed. In further embodiments, categories of user selectable options 214 can comprise a beverage type category, wherein each user selectable option 214 corresponds to a base type of the beverage to be dispensed, such as, for example, an option for a still beverage and an option for a sparkling beverage. In further embodiments, categories of user selectable options 214 can comprise any one or any combination of a carbonation level category, flavor intensity category, a temperature category, a volume category. The foregoing option categories may be relevant in embodiments wherein product dispensing machine 200 is configured to dispense beverages, but other option categories may exist in addition or instead in further embodiments wherein product dispensing machine 200. In the example shown in FIG. 2, user interface 210 displays user selectable options 214 in a flavor category comprising water and various fruit flavors, though the displayed categories and displayed options 214 within each category can vary in further examples. For example, in some embodiments, user interface 210 can display user electable options in a beverage type category comprising user selectable options 214 corresponding to still and sparkling beverages. In some such embodiments, user interface 210 can display the beverage type category user selectable options 214 either on the same page as the flavor category user selectable options 214 or on a different page to be accessed before or after making a flavor selection. Additionally, controller 218 may be configured to store and manage user selectable options 214 and categories of user selectable options 214 beyond those displayed by user interface 210 at any one time.

Controller 218 can be configured to rank user selectable options 214 by priority. In some embodiments, controller 218 can be configured to rank user selectable options 214 within a category by priority. In further embodiments, controller 218 can be configured to rank user selectable options 214 by priority independently in different categories. In further embodiments, controller 218 can be configured to rank user selectable options 214 in some categories and not to rank user selectable options 214 in other categories. For example, controller 218 can be configured to rank user selectable options 214 within the flavor category by priority, and to rank user selectable options 214 in any other categories independently from user selectable options 214 within the flavor category or not at all.

Controller 218 can further be configured to control user interface 210 to display user selectable options 214 differently depending on the options' priority. For example, in some embodiments, controller 218 can be configured to control user interface 210 to display user selectable options 214 in order of priority. In further embodiments, controller 218 can be configured to control user interface 210 to display user selectable options 214 with different levels of prominence depending on the options' priority. In further embodiments, controller 218 can be configured to control user interface 210 to only display user selectable options 214 above a predetermined priority within a category. Thus, controller 218 can be configured to control user interface 210 to not display user selectable options 214 within the category below the predetermined priority. In further embodiments, controller 218 can be configured to select a highest priority user selectable option 214 within a category by default.

Controller 218 can be configured to control user interface 210 to display user selectable options 214 differently by ranking within different categories. For example, controller 218 may be configured to control user interface 210 to display user selectable options 214 within the flavor category in order of priority. In another example, if a sparkling beverage option is a highest priority option within the beverage type category, controller 218 may be configured to control user interface 210 to display the sparkling beverage option as selected by default. Where controller 218 controls user interface 210 to display multiple categories of user selectable options 214 simultaneously, controller 218 can be configured to control user interface 210 to change the display of user selectable options 214 based on priority in multiple displayed categories with changes in one category being mutually independent of changes in another category. For example, controller 218 can be configured to prioritize user selectable options 214 within the beverage type category independently of user selectable options 214 in the flavor category and to prioritize user selectable options 214 within the flavor category independently of user selectable options 214 in the beverage type category. In further examples, controller 218 can be configured to control user interface 210 to simultaneously display user selectable options 214 within the beverage type category and user selectable options 214 within the flavor category, and to change which user selectable option 214 within the beverage type category is displayed as selected by default based on priority while independently changing which order user selectable options 214 within the flavor category are displayed based on priority.

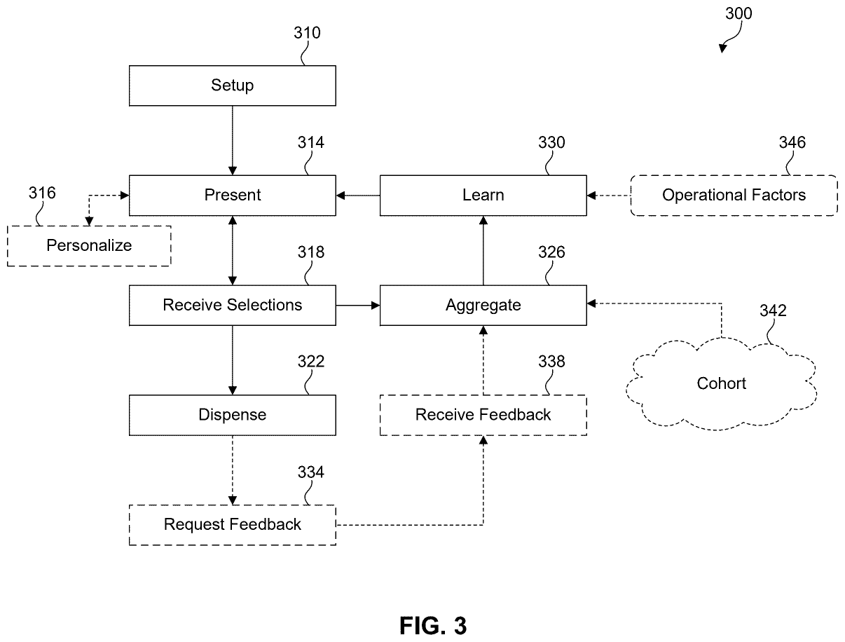

FIG. 3 shows an operating process 300 for product dispensing machine 200. Process 300 comprises a setup step 310. In setup step, controller 218 of product dispensing machine 200 can be configured with initial information. The initial information can comprise a group of user selectable options 214 to be made available by product dispensing machine 200. In some embodiments, the initial information can further comprise default priorities for the user selectable options 214. In some embodiments, the initial information can further comprise background information, such as records of previous sales or results of marketing research, that controller 218 can use in learn step 330 as will be discussed further below.

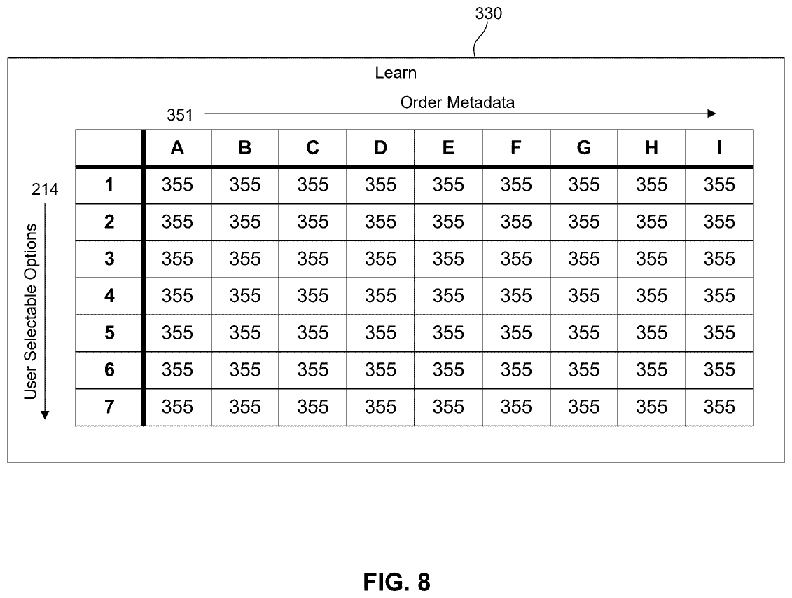

Process 300 further comprises a present step 314 following setup step 310. Present step 314 comprises controller 218 controlling user interface 210 to present user selectable options 214, such as by displaying user selectable options on a screen. Process 300 further comprises a receive step 318. After controller 218 has controlled user interface 210 to display user selectable options 214 in present step 314, controller 218 can receive user selections of the displayed user selectable options 214 through user interface 210 in receive step 318. In some embodiments, controller 218 can continue present step 314 after receiving a user selection in receive step 318. Present step 314 and receive step 318 may therefore overlap in some embodiments. For example, in some embodiments, controller 218 can control user interface 210 to continue presenting user selectable options 214 after a user has made an initial user selection until user interface 210 receives a confirmation input that causes controller 218 to finalize the user selection. In some further embodiments, controller 218 can continue present step 314 after receiving a user selection in receive step 318 by responding to receipt of user selections through user interface 210 by controlling user interface 210 to present further user selectable options 214. For example, controller 218 according to some embodiments can respond to a user selection of a beverage flavor user selectable option 214 by controller user interface 210 to present a dispensation parameter user selectable option as described further below with regard to FIG. 8A.

Process 300 further comprises a dispense step 322 after receive step 318. In dispense step 322, controller 218 controls dispenser 222 of product dispensing machine 200 to dispense a product according to the received user selections.

Process 300 further comprises an aggregate step 326. Aggregate step 326 can comprise ongoing aggregation of information. The information aggregated in aggregate step 326 can comprise the user selections received in receive step 318. In some embodiments, the information aggregated in aggregate step 326 can further comprise metadata of the aggregated user selections. The aggregated metadata can comprise, for example, any one or any combination of a time of a user selection, date of a user selection, price of a user selection, demographic information about a user that made a user selection, and an identity of a user that made a user selection.

Process 300 further comprises a learn step 330. Learn step 330 comprises controller 218 analyzing the data aggregated in aggregate step 326 and determining whether to change display instructions to user interface 210. Learn step 330 thus leads back to present step 314. Learn step 330 can comprise analyses to discover changes to display instructions that may improve user satisfaction, increase revenue at product dispensing machine 200, or both. In some embodiments, learn step 330 can further comprise reducing the weight of old data relative to new data or discarding old data altogether.

The foregoing description of steps 310, 314, 318, 322, 326, 330 represents some embodiments of process 330. Further embodiments of process may comprise the steps in different orders, may comprise less than all of the above described steps, and may comprise further steps in addition to any combination of the above described steps. Certain optional additional features that may be implemented in some embodiments of process 300, and may be omitted in other embodiments of process 300, are illustrated with broken lines in FIG. 3.

One such optional additional feature is a personalize step 316. Personalize step 316 comprises user interactions with product dispensing machine 200 that provide controller 218 with information controller 218 uses to personalize other aspects of process 300 for a specific user. In some embodiments, personalize step 316 may overlap with present step 314 as controller 218 may control user interface 210 to present options for personalizing a user's experience.

In some embodiments, personalize step 316 can product dispensing machine 200 accepting user interactions to sign into a user account. In some such embodiments, product dispensing machine 200 can personalize present step 314, dispense step 322, or both present step 314 and dispense step 322 according to information assigned to the user account. In some embodiments, product dispensing machine 200 can personalize present step 314 by controller 218 using preference data assigned to the user account as a factor in prioritizing user selectable options 214. In some embodiments, product dispensing machine 200 can personalize dispense step 322 by charging a payment method assigned to the user account for a dispensed product.

In some embodiments, preference data can comprise preferences provided expressly by the user through user interface 210. For example, during personalize step 316, controller 218 can control user interface 210 to present the user with user selectable options 214 corresponding to preferences that a user may have among the product types and parameters available from product dispensing machine 200. For example, in some embodiments wherein product dispensing machine 200 is a beverage dispenser, user interface 210 may present user selectable options 214 corresponding to flavor preferences, such as sweet, sour, or bitter, ingredient preferences, such as fruit or dairy, temperature preferences, carbonation level preferences, caffeine level preferences, or any combination of the foregoing.

In further embodiments, preference data can comprise conclusions drawn by controller 218 about a user's preferences during a previous learn step 330 based on the user's inputs in a previous personalize step 316, the user's selections received in a previous receive step 318, or both. Thus, in some embodiments, controller 218 can learn from the user's expressly given preferences in combination with the user's actual purchase activity.

As noted above, controller 218 according to some embodiments can be configured to personalize present step 314 by using preference data assigned to a signed-in user account as a factor when prioritizing user selectable options 214. Thus, in some embodiments, user interface 210 may present user selectable options 214 meeting a user's preferences as represented by the preference data assigned to a signed-in user account more prominently than other user selectable options. As will be discussed further below, user interface 210 may present high priority user selectable options 214 prominently by, for example, highlighting the high priority user selectable options 214, presenting the high priority user selectable options 214 at the front of a list 230, or by not displaying lower priority user selectable options 214.

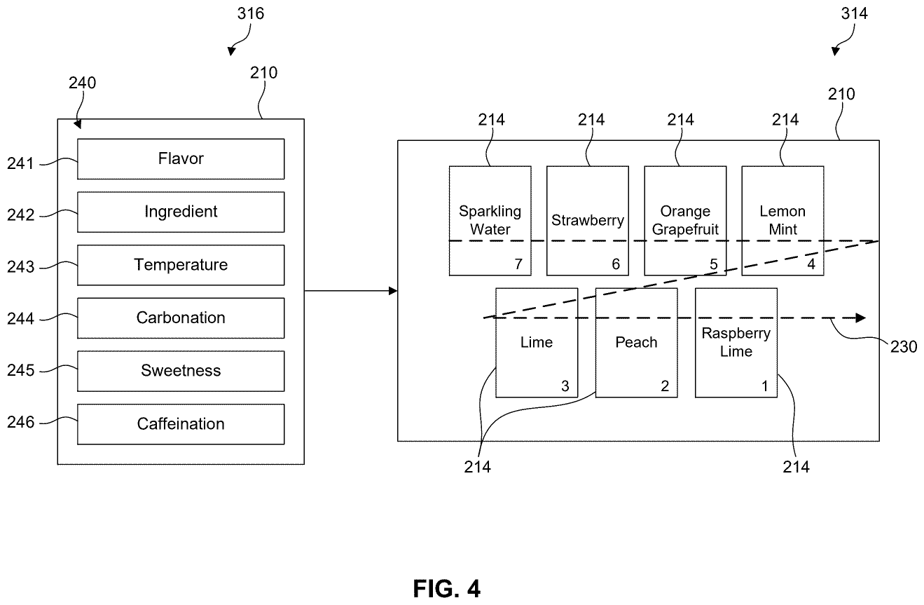

FIG. 4 illustrates an example of what user interface 210 can display in the above described sequence of receiving user preferences then displaying user selectable options 214. User interface 210 can display a preference input page 240 that includes one or more fields for user preferences. The fields of the illustrated example include a flavor field 241, ingredient field 242, temperature field 243, carbonation field 243, sweetness field 245, and caffeine level field 246. Preference input page 240 according to other embodiments may include any subset of these fields and may include other fields not specifically mentioned here. Additionally, preference input page 240 according to other embodiments may include multiple sub-pages each having one or more fields, and such fields may depend on inputs to fields in previous sub-pages. User inputs to fields can be made through, for example, drop down menus, radio buttons, check boxes, voice inputs, or text inputs.

After a user indicates to product dispensing machine 200 that the user is finished with the preference input page 240, user interface 210 can proceed to present step 314. In present step 314, user interface 210 may present user selectable options 214 in a manner prioritized based on inputs received through preference input page 240. Thus, in various examples, user interface 210 may filter the displayed user selectable options 214 to include only user selectable options 214 above a certain priority threshold, may display user selectable options 214 in a list 230 ordered by priority, or may otherwise increase visual prominence on high priority user selectable options 214. Ways user interface 210 may vary the presentation of user selectable options based on priority are discussed in greater detail below. In some embodiments, the relative priorities of user selectable options 214 may depend at least in part upon inputs to preference input page 240. In some embodiments, the relative priorities of user selectable options 214 may depend upon a combination of factors that includes inputs to preference input page 240 in addition to other factors that affect priority described elsewhere herein.

Returning to FIG. 3, another optional additional feature is a feedback sub-process comprising feedback request step 334 and feedback receipt step 338. Feedback request step 334 comprises requesting feedback from a user after dispense step 322. Feedback request step 334 can comprise controller 218 controlling user interface 210 to display a request for feedback. Thus, in some embodiments, after dispense step 322, user interface 210 can display a request for feedback that the user may respond to through further inputs to user interface 210.

In other embodiments, feedback request step 334 can comprise sending a request for feedback by any line of communication associated with a user account to which the user selections of a completed receive step 318 are assigned. Such lines of communication can comprise, for example, an email address, a telephone number, a computer or smart device application, or any other means of communication. Thus, in some embodiments, a user may sign into a user account through user interface 210 or scanner 226 such that user selections made during receive step 318 may be assigned to the user account, and after dispense step 322, controller 218 may communicate with a server that may in turn cause a request for feedback to be sent to a line of communication associated with a user account. Such requests for feedback can comprise, for example, sending an email to an email address associated with the user account, sending a text message to a telephone number associated with the user account, sending a message through an instance of a computer or smart device application where the user account is signed in, or any other form of communication.

Requests for feedback sent in feedback request step 334 can comprise any query that may be relevant to product dispensing machine 200 or its operators. Requests for feedback sent in feedback request step 334 can therefore comprise, for example, a query about user satisfaction with product dispensing machine 200, user satisfaction with presentation of user selectable options 214 on user interface 210, user satisfaction with a range of user selectable options 214 available, user satisfaction with a range of products available from product dispensing machine 200, or any combination of the foregoing. In further embodiments, requests for user feedback sent in feedback request step 334 can comprise a query about, for example, user interest in any predetermined product not yet available from product dispensing machine 200, a user's reason for selecting a selected user selectable option 214, a user's reason for not selecting a user selectable option 214, a user's opinion on a price associated with any user selectable option 214, or any combination of the foregoing.

Feedback receipt step 338 comprises receiving a user's response to a request for feedback made during feedback request step 334. Responses received in feedback receipt step 338 can be aggregated in aggregate step 326 for analysis by controller 218 in a following learn step 330. In some embodiments, users can provide responses through the same medium used to send a request for feedback. Thus, in some embodiments wherein feedback request step 334 comprises presenting a request for feedback through user interface 210, feedback receipt step 338 can comprise receiving a user's response to the request through user interface 210. In further embodiments wherein feedback request step 334 comprises sending a request for feedback through another line of communication associated with a user account, feedback receipt step 334 can comprise receiving a user's response to the request through the same line of communication, such as by a reply text message, a reply email, or a responsive input to a computer or smart device application.

In embodiments wherein requests for feedback sent in feedback request step 334 comprise any query relating to user satisfaction with any factor, learn step 330 can comprise controller 218 analyzing aggregated data and formulating an intervention to increase user satisfaction with the factor. Interventions can comprise any action controller 218 can execute. After formulating and enacting an intervention to increase user satisfaction with a factor, the feedback sub-process can be repeated by requesting further feedback concerning user satisfaction with the factor in feedback request step 334 and receiving feedback concerning user satisfaction with the factor in feedback receipt step 338. In some such embodiments, after aggregating the further feedback in aggregate step 326, a further learn step 330 can comprise analyzing the aggregated further feedback to detect any effect the implemented intervention had on the factor, then maintaining, discarding, or altering the intervention to optimize user satisfaction with the factor based on any such detected effect. Factors, for this purpose, can comprise any of the factors about which a user's satisfaction may be asked in any of the example queries listed above. Factors for this purpose can therefore comprise, for example, product dispensing machine 200 itself, presentation of user selectable options 214 on user interface 210, a range of user selectable options 214 available, or a range of products available from product dispensing machine 200. Thus, in some embodiments, feedback request step 334 can comprise requesting user feedback regarding user satisfaction with presentation of user selectable options 214 on user interface 210, and learn step 330 can comprise controller 218 analyzing feedback received in feedback receipt step 338 and formulating an intervention to improve user satisfaction with presentation of user selectable options 214. In some such embodiments, the intervention can comprise a change to controller's 218 instructions to user interface 210 affecting presentation of user selectable options 214. In some such embodiments, after formulating and implementing the intervention, a further feedback request step 334 can comprise presenting or sending a further query about user satisfaction with presentation of user selectable options 214 on user interface 210, and a further learn step 330 can comprise controller 218 analyzing an answer to the further query to detect any effect the change to controller's 218 instructions to user interface 210 may have had on user satisfaction with presentation of user selectable options 214 on user interface 210. In some such embodiments, the further learn step can comprise maintaining, discarding, or altering the change to controller's 218 instructions to user interface 210 to optimize user satisfaction with presentation of user selectable options 214 on user interface 210 based on any detected effect.

In further embodiments, learn step 330 can comprise analyzing user feedback provided in response to any queries used in feedback request step 334 and formulating an intervention to optimize revenue at product dispensing machine 200. In some embodiments, further learn steps 330 after implementing an intervention can comprise analyzing revenue trends to detect any effect the implemented intervention had on revenue and maintaining, discarding, or altering the intervention to optimize revenue based on any detected effect. For example, in some embodiments, if feedback request steps 334 comprise issuing queries that lead to feedback in feedback receipt step 338 that a price associated with a user selectable option 214 is too high, learn step 330 can comprise controller 218 analyzing the feedback and lowering the price. In some such embodiments, further learn steps 330 after the controller 218 lowers the price can comprise analyzing revenue trends to detect whether lowering the price led to an increased purchase volume and net improvement in revenue, and to maintain, discard, or alter the price change to optimize revenue in view of the outcome of the analysis.

Another optional additional feature of process 300 is inclusion of data from a cohort 342 of other product dispensing machines in the data aggregated in aggregate step 326. Cohort 342 can comprise other machines sharing a characteristic with product dispensing machine 200. In some embodiments, cohort 342 can be limited to other machines sharing the characteristic with product dispensing machine. In some embodiments, the characteristic can comprise presence within a geographic area. Thus, in some embodiments, cohort 342 can be limited to machines sharing the characteristic of being installed within a predetermined geographic region. In some embodiments, the geographic area can be predefined by a human operator. In further embodiments, the geographic area can be an area within a predefined distance of product dispensing machine. In other embodiments, the geographic area can be defined dynamically by a processor, such as a controller, based on commonality in usage patterns for machines in contiguous areas. Thus, in some embodiments, machines that are located in contiguous areas and experience usage patterns meeting a metric of similarity may be included in cohort 342. In further embodiments, the characteristic can comprise machines meeting a metric of similarity in userbase demographics.

In some embodiments, controller 218 can weight data received from cohort 342 differently than data received directly by the product dispensing machine 200 comprising controller 218 in learn step 330. Thus, in learn step 330, controller 218 may respond differently to data received from cohort 342 than to data received directly at product dispensing machine 200. In some such embodiments, controller 218 can give data received from cohort 342 less weight than data received directly by the product dispensing machine 200 comprising controller 218. Thus, in some embodiments, product dispensing machine 200 may be affected less by data received from cohort 342 than by data received directly at product dispensing machine 200.

In terms of system 100 and intelligent distribution system 120 described elsewhere herein, cohort 342 of some embodiments can comprise machines 140 installed within a same business establishment as product dispensing machine 200. In further embodiments, cohort 342 can comprise other machines 140 supplied by the same end distribution device 132 or devices 132 as product dispensing machine 200. In further embodiments, cohort 342 can comprise other machines 140 supplied by the same regional distribution device 128 or devices 128. Thus, in various embodiments, data received from cohort 342 for the purpose of process 300 can comprise portions of retail data, end distribution data, or regional distribution data as described elsewhere herein with respect to systems 100, 120. Information generated and used in process 300 can therefore affect and be affected by analytical structures implemented at various levels of an organization's distributions systems and business strategy. In some embodiments according to any of the foregoing, product dispensing machine 200 can comprise an individual machine 140. In some embodiments according to any of the foregoing, each machine 140 can comprise another product dispensing machine 200.

Another optional additional feature of process 300 is the supply of operational factors 346 to processor 218 for consideration in learn step 330. Operational factors 346 can comprise any information provided to controller 218 outside of the usage data aggregated within aggregate step 326. Operational factors 346 can therefore comprise, for example, any information bearing on the favorability of any user selectable options 214 from the perspective of an operator of product dispensing machine 200. In learn step 330, controller 218 may weigh such operational factors 346 against data from aggregate step 326 when developing instructions for user interface 210. In further embodiments, controller 218 may weight data from aggregate step 326 based on operational factors 346.

In some embodiments, operational factors 346 can comprise factors for improving user experience based on information outside of the user's knowledge. For example, in the interest of providing users with fresh ingredients while minimizing waste, operational factors 346 in some embodiments may comprise time until expiration of individual products or product ingredients, wherein products are discarded upon expiration. In some such embodiments, learn step 330 may comprise increasing priority of user selectable options 214 as the time before products or product ingredients associated with those user selectable options 214 decreases. Accordingly, in some embodiments, controller 218 can be configured to further change the relative priorities of user selectable options 214 by increasing priority of any user selectable options 214 that require usage of any ingredient stocked for product dispensing machine 200 and having an expiration date less than a predetermined amount of time in the future. In further embodiments, controller 218 can be configured to further change the relative priorities of user selectable options 214 by increasing priority of individual user selectable options 214 in inverse proportion to time remaining before expiration of ingredients stocked for the vending machine and respective to those individual user selectable options 214. Thus, controller 218 may update user interface 210 based on the changing priorities to emphasize user selectable options 214 associated with products or product ingredients nearing expiration, thereby encouraging selection of those user selectable options 214. Wastage may therefore be reduced without compromising the freshness of products and product ingredients provided to users.

In further embodiments, operational factors 346 can comprise business related factors. For example, operational factors 346 can comprise information about which products an operator of product dispensing machine 300 intends to promote. In learn step 330, controller 218 can increase priority of user selectable options 214 in proportion to the operator's interest in promoting the associated products. For example, if a new product and associated user selectable option 214 are added to product dispensing machine 200, an operator of product dispensing machine 200 may have an interest in promoting the new product, but the new user selectable option 214 may not appear in any of the data from aggregate step 326. Including the operator's interest in promoting the new product in operational factors 346 supplied to controller 218 can lead to controller 218 giving a relatively high priority to the associated new user selectable option 214 in learn step 330 despite the absence of the new user selectable option 214 from the data from aggregate step 326.

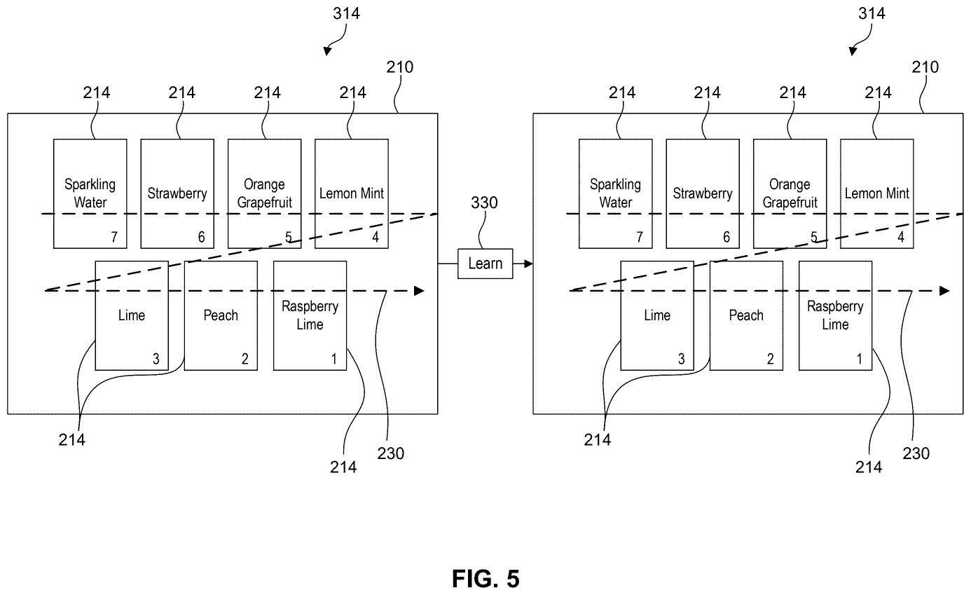

FIG. 5 shows a change in the presentation of user selectable options 214 by user interface 210 that controller 218 may implement following learn step 330 in some embodiments. In the example of FIG. 5, controller 218 controls user interface 210 to visually emphasize high priority user selectable options 214 by moving higher priority user selectable options 214 to positions of greater prominence within a list. In some embodiments, controller 218 may control user interface 210 to present user selectable options 214 in order of priority. Controller 218 may aggregate user selections of the user selectable options 214 as described above with regard to aggregate step 326. Controller 218 may change the relative priorities of user selectable options 214 based on the aggregated user selections. In some embodiments, controller 218 may change the relative priorities of user selectable options 214 based on the aggregated user selections within learn step 330. Controller 218 may then control user interface 210 to change the presentation of user selectable options 214 to reflect the changing of priorities.

For example, as shown in FIG. 5, user interface 210 may display user selectable options 214 in a list 230 ordered by priority. List 230 of the illustrated example is presented in two horizontal rows. However, in various embodiments, list 230 may be presented in any format, such as, for example, in vertical columns, in a line oriented in any direction, in a circle, or in any combination of formats. Additionally, list 230 of the illustrated example comprises seven user selectable options 214 each having a numbered priority from 1 to 7, but list according to various embodiments may comprise any plural number of user selectable options 214. Further, in various examples, user interface 210 optionally may or may not display the priority number of any user selectable option 214 within list.

As further shown in FIG. 5, user interface 210 may present user selectable options 214 in an initial order of priority within list 230. The initial priorities of user selectable options 214 for the initial order of priority may optionally be set during setup step 310 of process 300. In the illustrated example, A learn step 330 conducted based on aggregated data can change the relative priorities of user selectable options within list 230. Following learn step 330, controller 218 may control user interface 210 to present user selectable options 214 differently within list 230 to reflect changes to the relative priorities of user selectable options 214. In particular, in some embodiments controller 218 can be is configured to control user interface 210 to present the user selectable options 214 in a list 230, the list 230 being ordered by priority, and controller 218 can be configured to control user interface 210 to change an order in which user selectable options 214 are presented in the list 230 to reflect the changing of priorities.

FIG. 5 illustrates an example of how controller 218 can control user interface 210 to change the order in which user selectable options 214 are presented in a list 230. In the example of FIG. 5, an unflavored sparkling water user selectable option 214 has the highest priority and is therefore presented first within list 230. Further according to the illustrated example, a strawberry flavor user selectable option 214 has the second highest priority and is therefore presented second within list 230, and so on to a lowest priority user selectable option 214 of raspberry lime flavor that is presented last in list 230. The priority of the strawberry flavor user selectable option 214 may be lowered following learn step 330 based on aggregated user selections, resulting in the strawberry flavor user selectable option 214 being presented at a later position within list 230 after learn step 330. Similarly, the priority of an initially low priority user selectable option 214 such as the raspberry lime flavor user selectable option 214 may be increased in learn step 330, resulting in the raspberry lime flavor user selectable option 214 being presented at an earlier position within list 230 after learn step 330. Thus, cycles of learn step 330 and present step 314 may iteratively rearrange user selectable options within list 230 to arrive at a presentation found to be advantageous based on the factors processor 218 considers within learn step 330. Over time, such improvements may lead to more efficient interactions between users and product dispensing machine 200, improved sales, and improved user satisfaction.

User interface 210 may present one or more lists 230. In some embodiments, each list 230 may comprise only user selectable options 214 category among multiple categories of user selectable options 214. In the illustrated example of FIG. 5, learn step 330 changes the relative priorities of user selectable options 214 within a flavor category displayed in list 230, but does not affect the relative priorities of user selectable options 214 within a beverage type category comprising the “still” and “sparkling” options. Thus, in some embodiments, learn step 330 may change relative priorities of user selectable options 214 within one option category without affecting user selectable options 214 in another category. In further examples, learn step 330 may change relative priorities within multiple categories of user selectable options 214, with changes in different categories of user selectable options 214 being independent of one another.

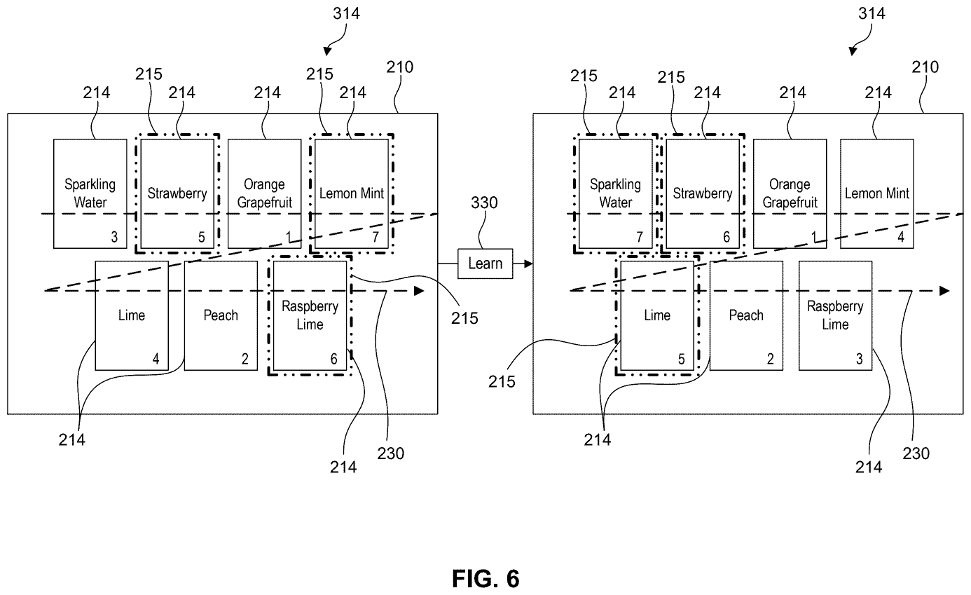

FIG. 6 illustrates another example of how the presentation of how user interface 210 may change the presentation of user selectable options 214 based on changing instructions of controller 218. In some embodiments, controller 218 controls user interface 210 to emphasize user selectable options 214 of higher priority by presenting them with a more visually prominent graphical feature than user selectable options 214 of lower priority.

In some embodiments, including the example illustrated in FIG. 6, controller 218 can control user interface 210 to change the emphasis of user selectable options 214 by varying the visual prominence of graphics used to display individual user selectable options 214 without changing the location of user selectable options 214. However, in further embodiments, controller 218 can control user interface 210 to change the emphasis of user selectable options 214 by both changing the visual prominence of graphics used to display user selectable options 214 and changing the location of user selectable options. Thus, in some embodiments, controller 218 and user interface 210 can employ a combination of the concepts described with respect to FIG. 5 and the concepts described with respect to FIG. 6 following a learn step 330.

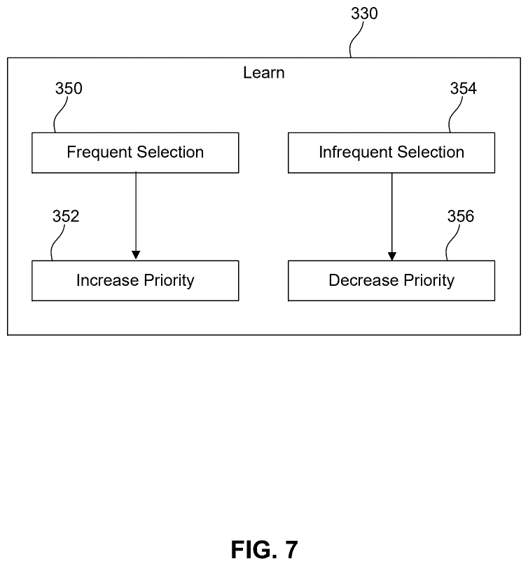

FIG. 7 shows an example of a process that may occur within learn step 330 according to some embodiments. In the example of FIG. 7, controller 218 can analyze data from aggregate step 326 to identify the relative proportions of user selections comprising various user selectable options 214. In some such embodiments, controller 218 can identify user selectable options 214 comprised by relatively large proportions of the aggregated user selections as frequent selections 350. At an increase step 352, controller 218 can increase the relative priority of the user selectable options 214 identified as frequent selections 350. In some embodiments, controller 218 can identify user selectable options 214 comprised by relatively small proportions of the aggregated user selections as infrequent selections 354. At a decrease step 356, controller 218 can decrease the relative priority of the user selectable options 214 identified as infrequent selections.

In some embodiments, within increase step 352, the magnitude of increase of priority for each user selectable option 214 among frequent selections 350 can be positively related to the proportion of the aggregated user selections that comprise that user selectable option 214. Thus, controller 218 of some embodiments may increase priority for more commonly selected user selectable options 214 among frequent selections 350 by a greater amount than less commonly selected user selectable options 214 among frequent selections 350. Similarly, in some embodiments, within decrease step 356, the magnitude of decrease of priority for each user selectable option 214 among infrequent selections 354 can be negatively related to the proportion of the aggregated user selections that comprise that user selectable option 214. Thus, controller 218 of some embodiments may decrease priority for less commonly selected user selectable options 214 among infrequent selections 354 by a greater amount than more commonly selected user selectable options 214 among infrequent selections 354. Accordingly, in some embodiments of learn step 330, controller 218 can be configured to change the relative priorities of user selectable options 214 by changing priority of individual user selectable options 214 in proportion to the individual user selectable options' 214 relative frequency within the aggregated user selections.

FIG. 8 shows another process that may optionally occur within learn step 330 according to some embodiments. The process illustrated in FIG. 8 comprises particularizing learning to different situations. Controller 218 according to some embodiments may then be able to particularize instructions to user interface 210 when those situations occur. The situations can comprise any factors that product dispensing machine 200 may be able to record as metadata 351 for any user selections acquired in receive step 318. Controller 218 according to some embodiments can analyze the metadata 351 connected to aggregated user selections to find associations 355 between user selectable options 214 and categories of the metadata 351. FIG. 8 presents an example of such analysis according to some embodiments, wherein for purposes of illustration categories of metadata 351 are labeled alphabetically and user selectable options 214 are labeled numerically. In the illustrated example, a separate discovered association 355 exists between each user selectable option 214 and category of metadata 351. In some further embodiments, within learn step 330 controller 218 may also be able to discover associations 355 between different user selectable options 214, associations 355 between different categories of metadata 351, or both.

Associations 355 can comprise, for example, how often a certain user selectable option 214 is comprised by user selections having a certain value for a certain category of metadata 351, how often a certain value of a certain category of metadata 351 occurs in user selections comprising a certain user selectable option 214, or both. For example, product dispensing machine 200 may be configured to record a time at which a user selection is received as metadata 351 for that user selection. The times at which user selections are made can therefore be among the information aggregated in aggregate step 326 and analyzed by controller 218 in learn step 330. In another example, metadata 351 can comprise user demographic characteristics. Accordingly, in some embodiments, controller 218 of product dispensing machine 200 can be configured to identify a characteristic of a user presently interacting with the product dispensing machine, to change relative priorities of user selectable options 214 based on the characteristic, and to control user interface 214 to change the presentation of user selectable options 214 to reflect the changing of the priorities. One example of such a user demographic characteristic is user age, but metadata 351 according to various embodiments may comprise any demographic characteristic information that users voluntarily provide. Demographic characteristic information about users that made some selections can therefore be among the information aggregated in aggregate step 326 and analyzed by controller 218 in learn step 330.

In other example, metadata 351 can comprise price of user selectable options 214. Prices of user selectable options 214 comprised by user selections can therefore be among the information aggregated in aggregate step 326 and analyzed by controller 218 in learn step 330. Thus, for example, controller 218 according to some embodiments may be able to learn over time whether users prefer colder beverages during the summer or whether older users prefer different flavors than younger users. Controller 218 according to some embodiments can therefore particularize its instructions to user interface 210 based on the situation, such as, for example, based on the time of day or based on the demographic characteristics of a user interacting with product dispensing machine 200, to present user selectable options 214 in a manner best suited to the situation.

Accordingly, controller 218 according to some embodiments may be configured to learn associations 355 between user selectable options 214 and times within a timeframe, and to particularize instructions to user interface 210 about the presentation of user selectable options 214 based on the current time within that timeframe. Timeframes for this purpose can comprise any repeating demarcation of time, including, for example, days, weeks, months, seasons, and years, or any combination of the foregoing. Thus, controller 218 according to some embodiments may be configured to send different instructions to user interface 210 at different times of day, and controller 218 according to some further embodiments may be configured to send different instructions to user interface 210 at different times of year. In some examples, controller 218 may be able to find an association 355 that a certain percentage of all user selections of a certain flavor user selectable option 214 occur in a particular month, or an association 355 that a certain percentage of all user selections at a particular time of day comprise a certain flavor user selectable option 214.

In some embodiments, controller 218 may similarly be configured to learn associations 355 between user selectable options 214 and various user demographic characteristics, and to particularize instructions to user interface 210 about the presentation of user selectable options 214 based the demographics of a user currently interacting with product dispensing machine 200. Thus, controller 218 of some embodiments can be configured to increase relative priorities of individual user selectable options 214 in proportion to a measure of the individual user selectable options' 214 popularity with users in the demographic category of a user currently interacting with product dispensing machine 200 by relying on learned associations 355.

In some embodiments, user accounts can be used to find user demographic information to be recorded as metadata 351 for some user selections, to find user demographic information for the purpose of particularizing controller's 218 instructions to user interface 210 about presentation of user selectable options 214, or both. For example, in some embodiments, controller 218 can use scanner 226 to optically recognize demographic characteristics of a user currently interacting with product dispensing machine 200.

In some embodiments, the assignment of user selections to user accounts may be used to particularize the prioritization of user selectable options 214. In some such embodiments, a user may voluntarily provide personal demographic information to be associated with the user account. In some such embodiments, the demographic information associated with any user account to which a user selection is assigned may be included as metadata of the user selection to be retained in aggregate step 326. In some such embodiments, when a user signs into a user account, controller 218 may particularize the relative priorities of user selectable options 214 based on the demographic information associated with the user account. Thus, controller 218 may control user interface 210 to emphasize user selectable options 214 selected frequently by users sharing demographic characteristics with the demographic information associated with the account.

In some further embodiments, a user may sign into a user account before making selections to be received in receive step 318. In some such embodiments, controller 218 may particularize its instructions to user interface 210 about presentation of user selectable options 214 based on demographic information associated with the user account. In some embodiments, controller 218 may assign selections made after the user signs into the user account and before completion of dispense step 322 to the user account. In other embodiments, the user may sign into the user account after making selections received in receive step 318, but before dispense step 322. In some such embodiments, controller 218 may assign the selections made during receive step 318 to the user account. In some embodiments wherein user selections are assigned to user accounts, any demographic information associated with a user account may be recorded by controller 218 as metadata of the user selections assigned to the user account.

In some embodiments wherein controller 218 uses the assignment of user selections to user accounts to particularize the prioritization of user selectable options 214, controller 218 may particularize the relative priorities of user selectable options 214 for individual user accounts. In some such embodiments, controller 218 may conduct learn step 330 independently for individual user accounts. In some such embodiments, when conducting learn step 330 for a particular user account, controller 218 may weigh user selections assigned to that particular user account more heavily than other data aggregated within aggregate step 326. In further embodiments, when conducting learn step 330 for a particular user account, controller 218 may ignore user selections not assigned to that particular user account. In some embodiments, conducting learn step 330 independently for an individual user account can comprise learning from user inputs received during personalize step 316 and receive step 318. In further embodiments, conducting learn step 330 independently for an individual user account can comprise generating preference data to be assigned to the individual user account.

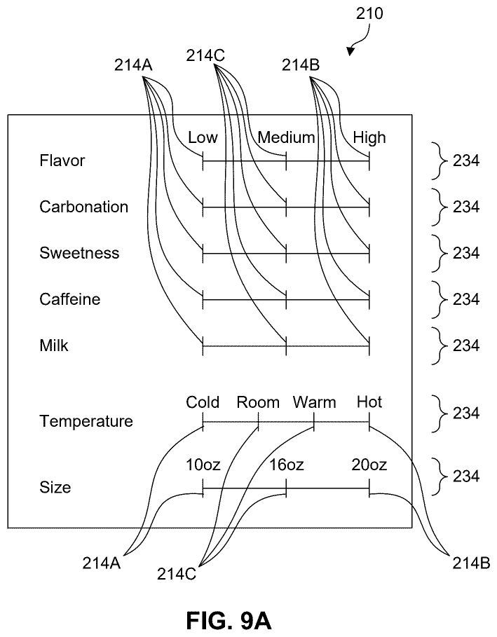

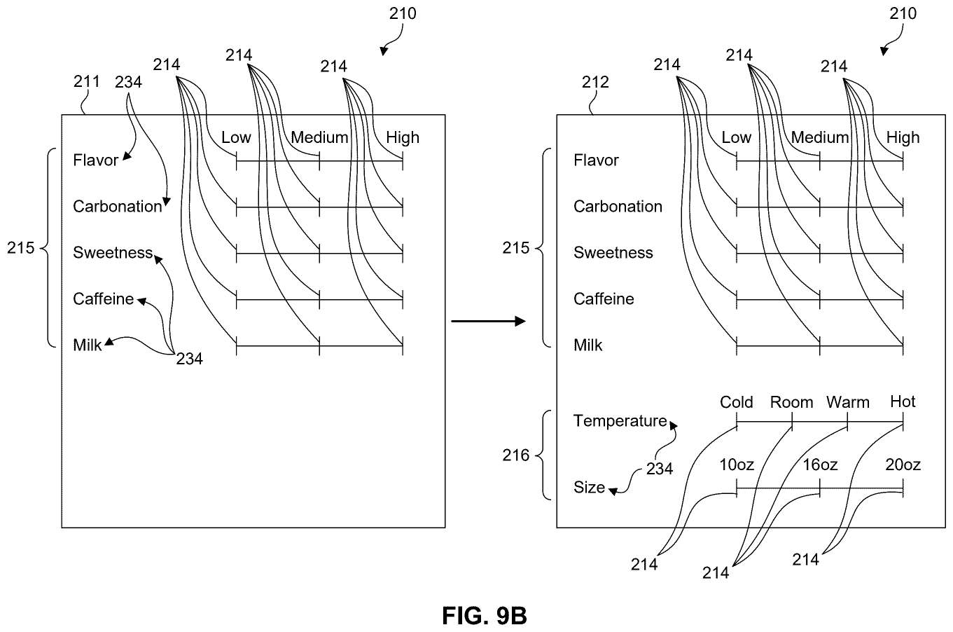

FIG. 9A illustrates an embodiment of user interface 210 comprising multiple options spectra 234. Each options spectrum 234 corresponds to a dispensation parameter and comprises multiple user selectable options 214 corresponding to different values of the dispensation parameter. Dispenser 222 can be configured to dispense a product in a manner that varies depending on the dispensation parameter's value. Dispensation parameters can be any quantifiable aspect of a product over which product dispensing machine 200 can be configured to give users control. In some embodiments, product dispensation parameters can comprise intensive properties of ingredients of the dispensed product, such as, for example, temperature or a ratio of product ingredients within an amount to be dispensed. In further examples, dispensation parameters can comprise extensive properties of ingredients of the dispensed product, such as a total mass or volume to be dispensed, or an amount of an additive ingredient to be included with an amount of base ingredient. In the illustrated example, the product dispensation parameters controllable through user interface 210 comprise, carbonation level, flavor level, temperature, sweetness, amounts of additives such as milk and caffeine, and volume, but the controllable dispensation parameters and their arrangement can vary in other embodiments. In some embodiments, controller 218 can control user interface 210 to present a dispensation parameter screen with one or more options spectra 234, such as the screen illustrated in FIG. 9A, following an initial selection on another screen, such as a selection of a flavor from the screen illustrated in FIG. 2. In further embodiments, controller 218 can be configured to control user interface 210 to present different options spectra 234 on different, sequential screens.

Controller 218 can be configured to, following selection of a user selectable option 214 within an options spectrum 234, set the dispensation parameter to the value to which the user selectable option 214 corresponds, then to control dispenser 222 to dispense a product according to the dispensation parameter. For example, in some embodiments, a flavor level options spectrum 234 can comprise multiple user selectable options 214. Each of the user selectable options 214 in the flavor level options spectrum 234 can correspond to a different value of a flavor level dispensation parameter. Dispenser 222 can be configured to include a variable amount of a flavoring ingredient when dispensing a beverage depending on flavor level dispensation parameter. Following selection of a user selectable option 214 within the flavor options spectrum, controller 218 can set the flavor level dispensation parameter to the value of the selected user selectable option 214 within the flavor level options spectrum 234, and then control dispenser 222 to dispense a product with an amount of the flavoring ingredient according to the flavor level dispensation parameter. In the illustrated example, the flavor level options spectrum comprises three user selectable options 214 listed in order of the magnitude of the value to which they correspond. As shown in the illustrated example, user selectable options 214 within options spectra 234 may further be labeled according to their magnitude. Thus, in various examples, user selectable options 214 may be labeled sequentially as “low,” “medium,” and “high” or “light,” “medium,” and “strong.”

Each options spectrum 234 comprises a first user selectable option 214A and a second user selectable option 214B. Within each options spectrum 234, first user selectable option 214A corresponds to a first value of the options spectrum's 234 dispensation parameter. Further, within each options spectrum 234, second user selectable option 214 corresponds to a second value of the options spectrum's 234 dispensation parameter, wherein the second value is different than the first value.

In some embodiments, an options spectrum 234 can comprise a third user selectable option 214C. Third user selectable option 214C can correspond to a third value of the options spectrum's 234 dispensation parameter, wherein the third value is between the first value and second value associated with the first user selectable option 214A and the second user selectable option 214B, respectively. In some embodiments, an options spectrum 234 can comprise multiple third user selectable options 214C that each correspond to a different value of the options spectrums' dispensation parameter between the first value and the second value. Optionally, controller 218 can control user interface 210 to present user selectable options 214 within an options spectrum 234 so that first user selectable option 214A, second user selectable option 214B, and any third user selectable options 214C within the options spectrum 234 are arranged in order of the values to which they correspond. Thus, as shown in the illustrated example, user interface may present an options spectrum 234 with a third user selectable option 214C arranged between the first user selectable option 214A and the second user selectable option 214B, wherein the third user selectable option 214C corresponds to a third value that is between the first value and the second value. Options spectra 234 of the illustrated example are arranged linearly, but options spectra 234 of further embodiments can be arranged in any shape or format.

In some embodiments, one or more of the values to which any user selectable options 214 in an options spectrum 234 correspond can be a variable value. In some embodiments, the third value, to which the third user selectable option 214C corresponds, can be a variable value. Thus, in some embodiments, third user selectable option 214C of an options spectrum 234 can be an individual user selectable option that corresponds to a variable value. Accordingly, in some embodiments, an individual user selectable option 214 can correspond to a variable value, and controller 218 can be configured to aggregate user selection and to change the variable value based on the aggregated user selections. In some such embodiments, controller 218 can be configured to, following selection of the individual user selectable option 214C, set the product dispensation parameter to the variable value and control the dispenser 222 to dispense the product according to the product dispensation parameter. In some such embodiments, learn step 330 comprises controller 218 changing the variable value based on the information aggregated in aggregate step 326. In some such embodiments, controller 218 can be configured to change the variable value based on relative quantities of the first user selectable option 214A and the second user selectable option 214B within the aggregated user selections. In some such embodiments, learn step 330 can comprise controller 218 changing the variable value to be nearer to either the first value or the second value, depending on which of first user selectable option 214A and second user selectable option 214B is comprised by a greater proportion of the aggregated user selections.

In some embodiments, learn step 330 can comprise controller determining whether a disproportionate amount of the aggregated user selections comprise any user selectable option 214 within an options spectrum 234, and if so to change the variable value to which a third user selectable option 214C corresponds. For example, controller 218 can be configured to seek a predetermined distribution of first user selectable option 214A, second user selectable option 214B, and any third user selectable options 214C, and to change at least the variable value to which one or more third user selectable options 214C corresponds to reach that distribution. In some embodiments, the predetermined distribution may be, for example, a bell curve, a uniform distribution, or any other distribution. In learn step 330, controller 218 can compare the relative proportions of aggregated user selections comprising the user selectable options 214 within an options spectrum 234 to the predetermined distribution. If the relative proportions of aggregated user selections comprising the different user selectable options 214 deviates from the predetermined distribution by more than a predetermined amount, then at least one of the user selectable options 214 must be comprised by a disproportionate amount of the aggregated user selections.

In further embodiments, controller 218 can determine whether a disproportionate number of aggregated user selections comprise a specific user selectable option 214 by determining whether at least a threshold proportion of the aggregated user selections comprise a specific user selectable option 214. In some such embodiments, the threshold proportion can be a predetermined proportion. In further embodiments, the threshold proportion can be a function of a proportion of the aggregated user selections that comprise a different user selectable option 214 within the same options spectrum. For example, in some embodiments, controller 218 may be configured to determine that a disproportionate number of aggregated user selections comprise the first user selectable option 214A of an options spectrum 234 if the proportion of the aggregated user selections comprising the first user selectable option 214A exceeds a threshold proportion that is a function of the second user selectable option 214B of the same options spectrum 234. Thus, in some embodiments, controller 218 may determine that a specific user selectable option 214 is selected disproportionately often by comparing the number of times that user selectable option 214 has been selected to the number of times another user selectable option 214 in the same options spectrum 234 has been selected.

In some embodiments wherein controller 218 is configured to determine whether a disproportionate amount of the aggregated user selections comprise any user selectable option 214, if controller 218 finds that at least one of the user selectable options 214 is comprised by a disproportionate amount of the aggregated user selections, learn step 330 can further comprise controller 218 changing the variable value to bring future user selections nearer to the predetermined distribution. In some such embodiments, controller 218 can change the variable value by bringing nearer to the value to which the disproportionately selected user selectable option 214 corresponds. For example, if controller 218 finds that a disproportionately large amount of aggregated user selections comprise second user selectable option 214B (“High”) within a carbonation level options spectrum 234, controller 218 can increase the variable value to which the third user selectable option 214C (“Medium”) within the same options spectrum 234 corresponds. The increase of the variable value may be expected to cause more users to select the third user selectable option 214C, thereby bringing user selection patterns closer to the predetermined distribution, because the disproportionately large number of selections comprising the second user selectable option 214B suggests that users'average carbonation level preference is greater than the average carbonation value offered by the previous state of the carbonation level options spectrum 234.

In some embodiments, the first value to which first user selectable option 214A corresponds can also be a variable value. In some embodiments, the second value to which second user selectable option 214B corresponds can also be a variable value. Thus, in addition to changing the value to which any third user selectable option 214C corresponds, learn step 330 according to some embodiments can comprise controller 218 changing a lower bound of the range of values of a dispensation parameter presented by user interface 210 to bring future user selection patterns nearer to the predetermined distribution, changing an upper bound of the range of values of the dispensation parameter presented by user interface 210 to bring future user selection patterns nearer to the predetermined distribution, or both.

In some embodiments, user interface 210 can transition from a first stage 211 to a second stage 212 in response to receipt of user selections. The second stage 212 may present a secondary group 216 of user selectable options 214 not presented by the first stage 211. Configuring controller 218 to control user interface 210 to transition from first stage 211 to second stage 212 may thereby reduce an amount of time that a user may require to complete a product order with beverage dispensing machine 200 by limiting the number of user selectable options 214 the user needs to consider at any time.

Further, in some embodiments, controller 218 may be configured to compose second group 216 of user selectable options 214 dependent upon user selections received through first stage 211 of user interface 210. In some such embodiments, controller 218 can be configured to compose second group 216 of user selectable options 214 relevant to user selections received through first stage 211 and thereby avoid presenting the user with user selectable options 214 inapplicable to the type of product the user intends to purchase.

In some embodiments, including the illustrated embodiment, the second stage 212 can continue to present user selectable options 214 among a primary group 215 presented by first stage 211. Thus, controller 218 may be configured to control user interface 210 to remain in first stage 211 until user interface 210 receives required selections among primary group 215, then to transition to second stage 212 by additionally presenting secondary group 216. In further embodiments, controller 218 may be configured to control user interface 210 to transition from first stage 211 to second stage 212 by replacing primary group 215 with secondary group 216.

In the illustrated embodiment, primary group 215 and secondary group 216 both comprise user selectable options 214 arranged in options spectra 234. In further embodiments, primary group 215, secondary group 216, or both primary group 215 and secondary group 216 may lack user selectable options 214 arranged in options spectra 234. For example, in some embodiments, primary group 215 may comprise beverage type user selectable options 214 not included by any options spectrum 234, and controller 218 may be configured to respond to receipt of a user selection of a beverage type through first stage 211 of user interface 210 by composing secondary group 216 of options spectra 234 relevant to the selected beverage type.

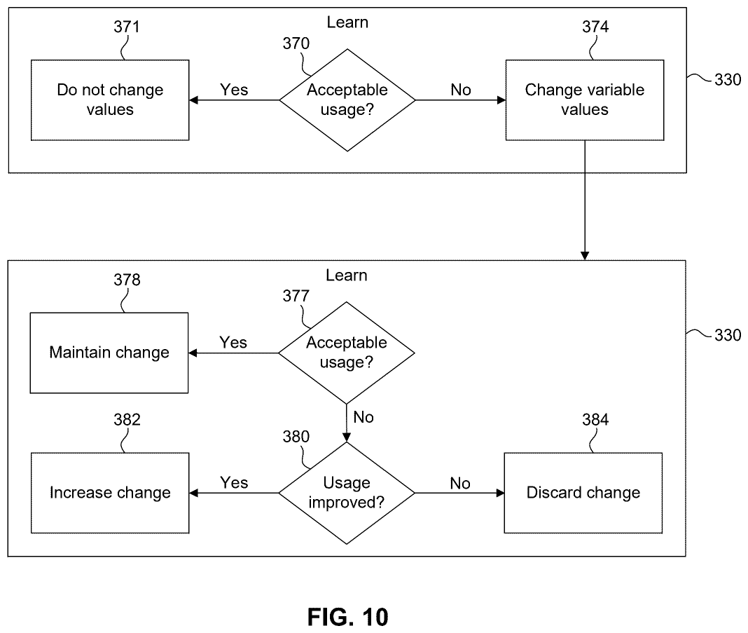

In some embodiments, learn step 330 can comprise evaluating the efficacy of previous changes made to any variable values corresponding to any user selectable options 214 within an options spectrum 234 in bringing patterns of user selections closer to the predetermined distribution. FIG. 10 shows an example according to some such embodiments. In some such embodiments, a first learn step 330 comprises controller 218 calculating a first deviation of user selection patterns of user selectable options 214 within an options spectrum 234. The first learn step 330 can further comprise a first determination 370 at which controller 218 determines whether the first deviation is equal to or less than a cutoff acceptable amount. If the first deviation is acceptable, the first learn step 330 can further comprise controller 218 leaving the variable values unchanged at a no change step 371. If the first deviation is unacceptable, the first learn step 330 can further comprise controller 218 changing at least one variable value to which any of the user selectable options 214 within the options spectrum 234 corresponds at change step 374. Following change step 374, a subsequent second learn step 330 can comprise controller 218 calculating a second deviation of user selection patterns of the user selectable options 214 within the options spectrum 234 based on data aggregated after the first learn step 330. In some embodiments, the second learn step 330 can further comprise a second determination 377 wherein controller 218 determines whether the second deviation is acceptable. If controller 218 finds that the second deviation is acceptable, controller 218 can maintain the change to the at least one variable value at maintain step 378. In some embodiments, the second learn step 330 can further comprise a third determination 380 wherein controller 218 determines whether the second deviation is smaller than the first deviation. In some embodiments, controller 218 may only execute third determination 380 if second determination 377 leads to a finding that the second deviation is not acceptable. If controller 218 finds that the second deviation is smaller than the first deviation, but greater than an acceptable amount, the second learn step 330 can comprise an increase step 382 wherein controller 218 increases the magnitude of the change of the at least one variable value, without changing the direction of the change. If controller 218 finds that the second deviation is greater than the first deviation, the second learn step 330 can comprise a discard step 384 wherein controller 218 discards the change to the at least one variable value.

The predetermined distribution of selections of user selectable options 214 within an options spectrum 234 can be a distribution expected to correlate with customers having a satisfactory range of options. For example, a pattern of user selections wherein user selections that comprise a specific user selectable option 214 within an options spectrum 234 far outnumber user selections that do not would suggest that the other user selectable options 214 within that options spectrum 234 may be assigned to values of the options spectrum's 234 dispensation parameter that users find unappealing. Thus, it may be possible to improve user satisfaction by predetermining a distribution of user selections that would be consistent with users having a variety of appealing options and configuring controller 218 to seek to conform actual user selection patterns to the predetermined distribution by dynamically alter the values of the dispensation parameter to which one or more user selectable options 214 correspond. In some embodiments, the predetermined distribution can be predetermined by a human operator. In some other embodiments, the predetermined distribution can be predetermined by controller 218 within earlier learn steps 330 by analyzing user feedback requested in feedback request step 334 and received in feedback receipt step 338.

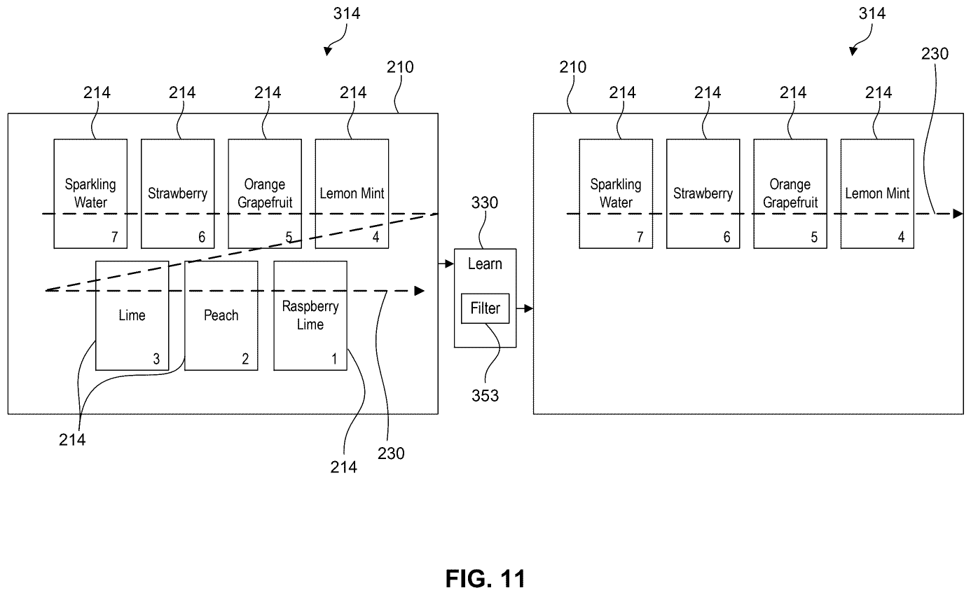

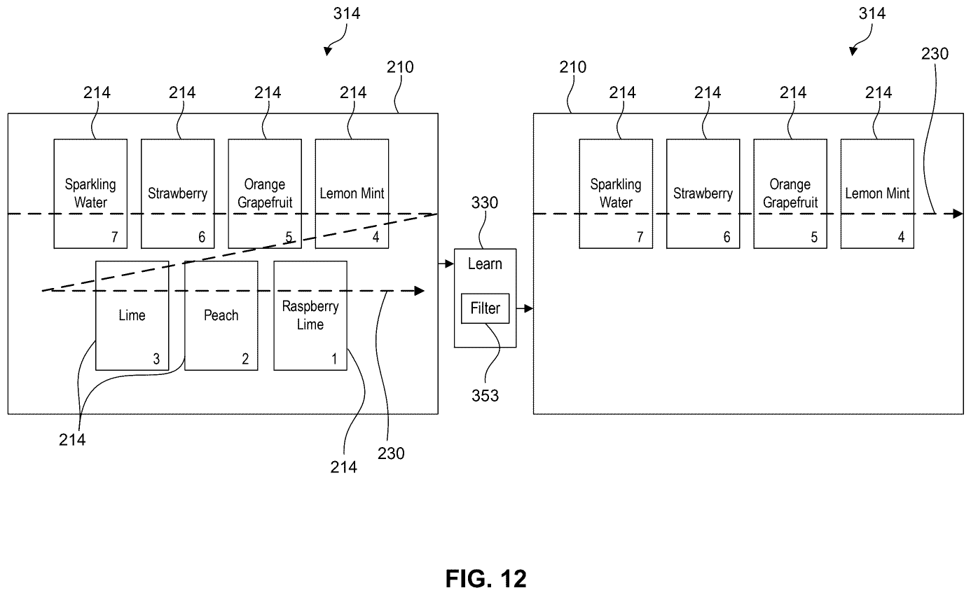

In some embodiments, learn step 330 can comprise a filter step 353 as shown in FIG. 11. Filter step 353 can comprise controller 218 selecting some user selectable options 214 to be excluded from presentation by user interface 210 and selecting other user selectable options 214 to be presented by user interface 210. Thus, after completing a learn step 330 that comprises a filter step 353, controller 218 can control user interface 210 to present user selectable options 214 corresponding to less than all product options that product dispensing machine 200 has available. In some such embodiments, after completing a learn step 330 that comprises a filter step 353, controller 218 can control user interface 210 to present all user selectable options 214 that were selected to be presented during filter step 353 and to not present any user selectable options 214 that were selected to be excluded from presentation during filter step 353. In some embodiments, filter step 353 can be applied to an individual category or multiple individual categories of user selectable options 214 independently of other categories of user selectable options 214. As shown in FIG. 12, subsequent learn steps 330 and filter step 353 can cause different user selectable options 214 to be displayed as controller 218 learns more.

In some embodiments, filter step 353 can comprise controller 218 selecting any user selectable options 214 below a cutoff priority to be excluded from presentation by user interface 210 and selecting any user selectable options 214 above the cutoff priority to be presented by user interface 210. Filter step 353 can therefore be implemented to limit the options available to users to user selectable options 214 of relatively high priority. Thus, in some embodiments, filter step 353 can make user interface 210 more efficient to interact with by causing user interface 210 to only present user selectable options 214 that users are most likely to select based on the aggregated data.

Like other possible features of learn step 330, filter step 353 according to some embodiments can be implemented separately for different situations. Thus, filter step 353 can cause user interface 210 according to some embodiments to present different user selectable options 214 in different situations. For example, as the time of day changes, or as different users use product dispensing machine 200, different situational associations discovered from analysis of metadata 351 may become relevant, and filter step 353 may then cause user interface 210 to present different subsets of all possible user selectable options 214 as situations change. Filtering user selectable options 214 differently in different situations can further improve the efficiency of interacting with user interface 210 by showing the most relevant user selectable options 214 for a given situation.

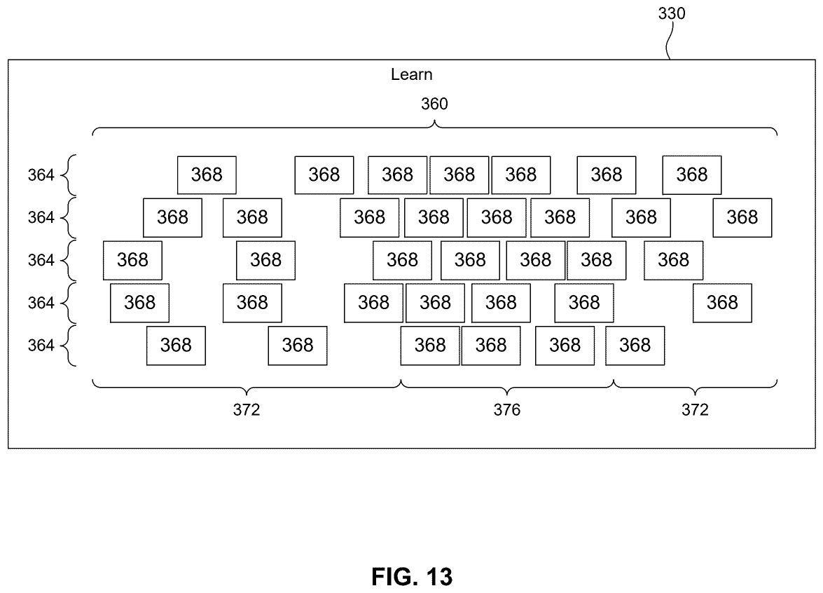

FIG. 13 illustrates a timeframe based learning operation comprised by some embodiments of learn step 330. In some embodiments of learn step 330, controller 218 can sort aggregated user selections 368 into iterations 364 of a timeframe 360. Timeframe 360 can be any repeating unit of time, such as, for example, days, weeks, months, or years. Thus, each iteration 364 can be, for example, a different day, week, month, year, or any other repeating unit of time.

Learn step 330 can comprise controller 218 analyzing how often user selections 368 occur throughout timeframe 360 to identify low frequency blocks 372 and high frequency blocks 376, wherein the low frequency blocks 372 are portions of timeframe 360 during which user selections 368 are generally less frequent than during the high frequency blocks 376. Controller 218 may, for example, analyze the times of aggregated user selections 368 in multiple iterations 364 of timeframe 360 to the frequency at which user selections 368 are made at various points throughout timeframe 360, on average.

In some embodiments, low frequency blocks 372 and high frequency blocks 376 can be separated by a cutoff average frequency. In some embodiments, the cutoff average frequency can be a defined by a predetermined constant value. In other embodiments, the cutoff average frequency can be calculated as a function of a lowest or highest average frequency found relative to timeframe 360. Thus, in some such embodiments, the cutoff between low frequency blocks 372 and high frequency blocks 376 can vary depending on the outer bounds of the range of user interaction frequencies that product dispensing machine 200 typically experiences. In further embodiments, the cutoff average frequency can be calculated as a function of an average amount of time users spend interacting with user interface 210 to complete a user selection 368. Thus, in some such embodiments, the cutoff between low frequency blocks 372 and high frequency blocks 376 can vary depending on how long an individual user typically needs to interact with a machine to complete a user selection 368. For example, controller 218 can be configured to measure an amount of time between a user beginning to interact with product dispensing machine 200 and that user completing a user selection 368 that results in product dispensing machine 200 dispensing a product. The controller 218 can be further configured to calculate an average of several such amounts of time to find the average amount of time a user needs to complete a user selection 368. The controller 218 can be further configured to set the cutoff average frequency to have a predetermined proportion to the average amount of time needed to complete a user selection 368. The predetermined proportion may be greater than one to one. Thus, during portions of timeframe 360 when users usually have to wait in line to use product dispensing machine 200, user selections 368 will tend to be spaced apart by an amount of time close to the average amount of time needed to complete a user selections 368. The frequency of user selections 368 during such portions of timeframe 360 may therefore usually fall below the cutoff average frequency, causing such portions of timeframe 360 to be designated as high frequency blocks 376.

In some embodiments, controller 218 can be configured to implement filter step 353 only during high frequency blocks 376 to streamline user interactions with product dispensing machine 200 during typically busy times while allowing more user selectable options 214 to be available during times when users are likely to have more time to interact with product dispensing machine 200.

Thus, in some embodiments, controller 218 can be configured to follow a schedule comprising a first block and a second block, and to control the user interface 210 to present fewer user selectable options 214 during the first block than the second block. In some embodiments, the schedule can be a schedule that repeats on a timeframe 330. In some embodiments, the first block of the schedule can be high frequency block 376 and the second block of the schedule can be low frequency block 372. Further, in some embodiments of learn step 330, controller 218 can be configured to create the schedule based on aggregated user selections 368 by analyzing the aggregated user selections 368 for patterns in frequency of interactions with user interface 210. In further embodiments of learn step 330, controller 218 can be configured to predict future frequencies of interactions with user interface 210 based on the patterns. In some such embodiments, the first block can be a time within the schedule for which controller 218 predicts greater frequency of interactions with user interface 210 than during the second block based on the patterns.

Reference is made herein to actions that may be performed by a controller 218 comprised by a product dispensing machine 200. For each such action, it is contemplated that, in some embodiments, all processing and data storage necessary to complete the action can be conducted on controller 218 hardware comprised by product dispensing machine 200. However, for each such action, it is also contemplated that, in other embodiments, some processing, data storage, or both processing and data storage necessary to complete the action can be conducted with external processing and memory resources with which controller 218 comprised by product dispensing machine 200 is in network communication. In further embodiments, various actions may be allocated to different processing hardware. Thus, for example, in some embodiments a controller 218 comprised by a product dispensing machine 200 can conduct learn steps 330 to learn information specific to the product dispensing machine 200, while an external processor in network communication with controllers 218 of multiple product dispensing machines 200 can conduct learn steps 330 to learn user preferences associated with user accounts accessible at the multiple product dispensing machines 200.

It is to be appreciated that the Detailed Description section, and not the Summary and Abstract sections, is intended to be used to interpret the claims. The Summary and Abstract sections may set forth one or more but not all exemplary embodiments of the present disclosure but are not intended to limit the present disclosure and claims in any way.

The foregoing description of the specific embodiments so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the claims and their equivalents.

What is claimed is:

1. A product dispensing machine comprising:
a user interface configured to receive user selections and to present user selectable options; and
a controller configured to control the user interface to present user selectable options in order of priority,
wherein the controller is configured to aggregate the user selections, to change relative priorities of the user selectable options based on the aggregated user selections, and to control the user interface to change a presentation of the user selectable options to reflect the changing of the priorities.

2. The product dispensing machine of claim 1, wherein the controller is configured to control the user interface to present the user selectable options in a list, the list being ordered by priority, and the controller is configured to control the user interface to change an order in which the user selectable options are presented in the list to reflect the changing of priorities.

3. The product dispensing machine of claim 1, wherein the controller is configured to change the relative priorities of the user selectable options by changing priority of individual user selectable options in proportion to the individual user selectable options' relative frequency within the aggregated user selections.

4. The product dispensing machine of claim 1, wherein the controller is configured to follow a schedule comprising a first block and a second block, and to control the user interface to present fewer user selectable options during the first block than during the second block.

5. The product dispensing machine of claim 4, wherein the controller is configured to create the schedule based on the aggregated user selections by analyzing the aggregated user selections for patterns in frequency of interactions with the user interface and to predict future frequencies of interactions with the user interface based on the patterns, and wherein the first block is a time within the schedule for which the controller predicts greater frequency of interactions with the user interface than during the second block based on the patterns.

6. The product dispensing machine of claim 1, wherein the controller is configured to further change the relative priorities of the user selectable options by increasing priority of user selectable options that require usage of any ingredient stocked for the product dispensing machine and having an expiration date less than a predetermined amount of time in the future.

7. The product dispensing machine of claim 1, wherein the controller is configured to further change the relative priorities of the user selectable options by increasing priority of individual user selectable options in inverse proportion to time remaining before expiration of ingredients stocked for the vending machine and respective to those individual user selectable options.

8. The product dispensing machine of claim 1, wherein the controller is configured to further change the relative priorities of the user selectable options based on user selections aggregated by a cohort of related dispensing machines.

9. The product dispensing machine of claim 8, the cohort is limited to a predefined geographic region within which the product dispensing machine is installed.

10. The product dispensing machine of claim 1, wherein the controller is configured to identify a characteristic of a user presently interacting with the product dispensing machine and to further change relative priorities of the user selectable options based on the characteristic.

11. A product dispensing machine comprising:
a user interface configured to present an options spectrum comprising user selectable options and to receive user selections of the user selectable options, wherein each of the user selectable options corresponds to a different value of a product dispensation parameter, wherein an individual user selectable option among the user selectable options corresponds to a variable value;
a dispenser configured to dispense a product in a manner that varies depending on the product dispensation parameter; and
a controller configured to:
aggregate the user selections and to change the variable value based on the aggregated user selections, and
following selection of the individual user selectable option, set the product dispensation parameter to the variable value and control the dispenser to dispense the product according to the product dispensation parameter.

12. The product dispensing machine of claim 11, wherein:
the options spectrum comprises a first user selectable option, a second user selectable option, and the individual user selectable option, wherein the first user selectable option corresponds to a first value of the product dispensation parameter, the second user selectable option corresponds to a second value of the product dispensation parameter, and the variable value is between the first value of the product dispensation parameter and the second value of the product dispensation parameter, and
the controller is configured to change the variable value based on relative quantities of the first user selectable option and the second user selectable option within the aggregated user selections.

13. The product dispensing machine of claim 12, wherein the controller is configured to change the variable value based on the relative frequencies of the first user selectable option and the second user selectable option by changing the variable value if at least a threshold proportion of the aggregated user selections comprise the first user selectable option.

14. The product dispensing machine of claim 13, wherein the threshold proportion is a predetermined proportion.

15. The product dispensing machine of claim 13, wherein the threshold proportion is a function of a proportion of the aggregated user selections that comprise the second user selectable option.

16. The product dispensing machine of claim 13, wherein the controller is configured to change the variable value to be nearer to the first value if at least the threshold proportion of the aggregated user selections comprise the first user selectable option.

17. The product dispensing machine of claim 11, wherein the product dispensation parameter is an amount of a product ingredient to be dispensed.

18. The product dispensing machine of claim 11, wherein the product dispensation parameter is an intensive property of a product ingredient to be dispensed.

19. A product dispensing machine comprising:
a user interface configured to receive user selections and to present user selectable options;
a scanner configured to identify a characteristic of a person, and
a controller configured to control the user interface to present user selectable options in order of priority, wherein the controller is configured to use the scanner to identify the characteristic of a user presently interacting with the product dispensing machine, to change relative priorities of the user selectable options based on the characteristic, and to control the user interface to change the presentation of the user selectable options to reflect the changing of the priorities.

20. The product dispensing machine of claim 19, wherein the characteristic is a demographic category, and the controller is configured to increase relative priorities of individual user selectable options in proportion to a measure of the individual user selectable options' popularity with users in the demographic category.
